(19) United States
(12) Patent Application Publication
(10) Pub. No.: US 2025/0335799 A1
(43) Pub. Date: Oct. 30, 2025

(54) MULTI-PASS PROCESSING FOR ARTIFICIAL INTELLIGENCE CHATBOTS

(71) Applicant: MicroStrategy Incorporated, Vienna, VA (US)

(72) Inventors: Paramjeet S. Sidhu, Herndon, VA (US); Ting Huang, Vienna, VA (US); Mohamed Diakite, Vienna, VA (US); Xiaoyan Yu, Annandale, VA (US); Ananya Ojha, Dunn Loring, VA (US); Jaime Alberto Perez, Brambleton, VA (US)

(21) Appl. No.: 19/193,502

(22) Filed: Apr. 29, 2025

Related U.S. Application Data
(60) Provisional application No. 63/640,861, filed on Apr. 30, 2024.

(51) Int. Cl. G06N 5/045; G06F 16/2455; G06F 16/28

(52) U.S. Cl. CPC G06N 5/045; G06F 16/2456; G06F 16/287

(57) ABSTRACT

Methods, systems, and apparatus, including computer-readable media, for multi-pass processing for artificial intelligence chatbots. In some implementations, a system obtains code or instructions generated by one or more artificial intelligence or machine learning (AI/ML) models, where the code or instructions specify criteria to retrieve data from a data source to respond to a prompt from a user. The system determines that the code or instructions specify multiple stages of data processing. The system generates a set of results from the data source based on the generated code or instructions, and obtains a response to the prompt that the one or more AI/ML models generate using at least a portion of the set of results. The system generates an interpretation statement that describes each of the multiple stages of data processing and provides output that includes (i) the response to the prompt and (ii) the generated interpretation statement.

### CROSS-REFERENCE TO RELATED APPLICATIONS

This application claims the benefit of priority to U.S. Provisional Patent Application No. 63/640,861, filed on Apr. 30, 2024, the contents of which are hereby incorporated by reference.

### BACKGROUND

The present specification relates to techniques for determining and revealing interpretations made by models for artificial intelligence and machine learning.

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users.

### SUMMARY

In some implementations, a computer system is configured to provide artificial intelligence or machine learning chatbots and other tools that use AI/ML models. The system can include the capability to process compound questions and perform complex data processing operations, including processing that involves multiple stages or successive rounds of data retrieval or data processing. For example, the computer system can use an AI/ML model to generate code or instructions for data processing, such as a SQL statement or segment of Python code. The computer system can analyze the code or instructions that the AI/ML model generates to identify when multiple stages of data processing are needed, such as a SQL statement that involves multiple passes or the creation of multiple tables. With this information, the computer system can retrieve the needed data from a database system or other data processing system, then provide the results from the database to the AI/ML model to generate a response to the user's original prompt (e.g., the user's question). This process can leverage the combination of inference by the AI/ML model (e.g., an LLM) to generate data processing code or instructions with analysis and execution of that code or instructions to perform non-AI processing using reliable database systems.

In some implementations, the computer system can also evaluate the interpretations that are available for portions of or all of a user's question to detect ambiguity or the availability of multiple interpretations. For example, the computer system can identify when terms in a users prompt to a chatbot may potentially correspond with multiple different data objects in a data set, such as different attributes or metrics or different columns in a data table. As another example, the computer system can ask an AI/ML model to assess the users question, together with a data model indicating data objects available, and indicate the potential interpretations of different terms or phrases. Using these or other techniques, the computer system can detect situations when multiple different interpretations are possible, and the computer system can also score or rank the potential interpretations. The most likely interpretation is used to generate the answer for the user. In addition, one or more alternative interpretations can be provided with the answer.

In this manner, even when there is vagueness or ambiguity in a user's question, the chatbot still provides an answer using the interpretation that is most likely, which provides the user a response as quickly as possible, while still acknowledging the existence of other interpretations that would lead to a different result. When conversing with an LLM-based chatbot, costs are typically incurred for each request. As a result, it is often most efficient to obtain a response from the LLM that answers a user question with the interpretation predicted to be most likely, even if the LLM is also requested to provide other alternative interpretations are requested. This way, the user receives an answer with low latency, and there is no need for a further request to the chatbot to explore the results with the alternative interpretation until the user affirmatively specifies that the alternative interpretation is desired.

For example, when the computer system determines that appropriate criteria are satisfied, the chatbot answer can include the second-most-likely interpretation (e.g., the predicted best alternative interpretation) to show the user the other option that was possible but not used. The alternative interpretation can be presented in the form of a question to the user that may facilitate further conversation with the chatbot. For example, a user may ask a question and request that data be aggregated by location. The data set may not include a “location” column, but instead includes several different geographical attributes, e.g., country, state, city, zip code, address, etc. When the AI/ML model uses a “country” attribute as the location, the computer system can, from its own analysis of the available attributes or based on the LLM's statements about the available interpretation, determine that state and city are also reasonably likely alternatives to interpret as the location referred to by the user. As a result, the computer system can include in the chatbot response a question that says, “Did you mean city or state as the location?”

The computer system can also make the question interactive in the user interface, such as by making the words city and state interactive controls. If the user interacts with one of the controls, the computer system can rerun the question with the new interpretation and provide the updated result. For example, if the user clicks the word or button representing city attribute, then the chatbot can re-run its analysis with the data selection, aggregation, filtering, or other processing being performed by city instead of by country, to show the new interpretation of location as city. As a result, because the computer system recognizes the availability of an alternative interpretation (e.g., an alternative mapping of data object(s) from a data set to terms or concepts in the user's question), and provides a user interface control to switch to the alternative interpretation (e.g., to re-run the query or analysis with the alternative mapping), the user can quickly and easily correct an interpretation that is not what the user intended and receive an updated chatbot response.

In some implementations, the computer system shows the option for an alternative interpretation selectively based on measures of relevance or the likelihood of different options. For example, the computer system can enter information about data objects in one or more data sets in a vector database. The computer system can then use the vector database to assess the similarity of a vector representation of a user's question, or portions of the question, with the vector representations of data objects, terms, concepts or other items represented in the vector database. The distance of the vector(s) from the user's question with the vectors of items in the database can be used to generate a similarity metric. The computer system can then evaluate those similarity scores to determine whether an alternative interpretation should be provided. For example, the computer system can set a threshold or multiple thresholds such that If the alternative interpretation is within a threshold level of similarity to the primary interpretation, then the alternative interpretation should be indicated and made available through the chatbot response.

In general, a chatbot system can improve the ability to answer compound and follow-up questions with multi-pass SQL processing. This feature can make a significant improvement in chatbot capabilities, by allowing multi-pass SQL methodology to answer user questions instead of being limited to a single-pass SQL approach. This enhancement can allow effective handling of complex, compound questions that require multiple SQL queries to generate precise answers. The multi-pass SQL approach can facilitate deeper, more nuanced data analysis, even in scenarios involving multiple datasets or data sources (e.g., data blending).

One important benefit is the ability of a chatbot to provide comprehensive, precise answers to compound questions in a seamless, conversational manner. For example, a user may ask, “In each of the top 5 stores by revenue, what are the top 3 sold product categories?” This type of query involves multiple steps, such as to first determine the top five stars by revenue and then to gather other information about that set of stores, e.g., the top three product categories by amount of sales. As discussed below, a computer system that provides chatbot functionality can facilitate this using multiple stages of processing, including first using an AI/ML model to generate code or instructions for data processing (e.g., data retrieval and calculations), and then using the results generated from executing the code or instructions using a database system. This effectively and efficiently leverages a database backend to handle complex operations, including multi-pass SQL statements, and using the generative capabilities of the AI/ML models to interpret or summarize the results and provide a natural language output to the user.

In one general aspect, a method performed by one or more computers includes: receiving, by the one or more computers, a prompt from a user; obtaining, by the one or more computers, code or instructions generated by one or more artificial intelligence or machine learning (AI/ML) models, wherein the code or instructions specify criteria to retrieve data from a data source to respond to the prompt; determining, by the one or more computers, that the code or instructions specify multiple stages of data processing; generating, by the one or more computers, a set of results from the data source based on the generated code or instructions; obtaining, by the one or more computers, a response to the prompt that the one or more AI/ML models generate using at least a portion of the set of results; generating, by the one or more computers, an interpretation statement that describes each of the multiple stages of data processing; and providing, by the one or more computers, output that includes (i) the response to the prompt and (ii) the generated interpretation statement.

In some implementations, the code or instructions comprise a structured query language (SQL) statement.

In some implementations, determining that the code or instructions specify multiple stages of data processing comprises determining that the SQL statement includes multiple select commands, includes a join command, or involves creation of multiple tables.

In some implementations, the method includes generating a set of visualization data for each of the multiple stages of data processing, including for an intermediate stage of data processing for which a visualization is not initially displayed when the response to the prompt is displayed. Each set of visualization data defines properties of a visualization for the stage of data processing including a visualization type and data types or data series to be represented in the visualization.

In some implementations, the method includes: generating a set of visualization data or a table of data for each of the multiple stages of data processing; and for at least one of the stages of data processing, saving a metric definition or a filter definition based on parameters from the set of visualization data or operations used to generate the table of data.

In some implementations, the interpretation statement includes, for each of the multiple stages of data processing: an indication of data objects used in the stage of data processing; and operations performed on the data objects to generate the output of the stage of data processing.

In some implementations, the one or more AI/ML models comprise a large language model (LLM).

In some implementations, the interpretation statement comprises a summary or description of information that the code or instructions are configured to obtain from the data source.

In some implementations, the interpretation statement indicates data objects or criteria used to retrieve the set of results.

In some implementations, the interpretation statement indicates at least one of (i) a mapping between one or more terms of the prompt to one or more corresponding data objects, wherein the mapping was determined by the one or more AI/ML models, or (ii) one or more formulas or equations that indicate how a portions of the set of results was calculated.

In some implementations, providing the output comprises providing output that causes a particular term of the prompt to be annotated or visual distinguished from other terms in the prompt. The interpretation statement designates an attribute, metric, or other data object that is interpreted to represent the particular term.

In some implementations, the code or instructions comprise executable or interpretable code.

In some implementations, the code or instructions include data filtering parameters or data aggregation parameters for generating the set of results; and the interpretation statement indicates the data filtering parameters or data aggregation parameters.

In some implementations, obtaining the code or instructions comprises providing, to the one or more AI/ML models, a data model or data schema for one or more data sources, wherein the code or instructions include references to data objects in the data model or data schema; and the interpretation statement includes references to the data objects in the data model or data schema.

In some implementations, the interpretation statement is generated by analyzing the code or instructions together with a data model or data schema for the data source.

In some implementations, the interpretation statement comprises text generated by the one or more AI/ML models in response to a request to summarize or explain interpretations used in the generated code or instructions.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for determining and revealing interpretations made by artificial intelligence or machine learning (AI/ML) models.

FIGS. 2 and 3 are diagrams showing examples of user interfaces that display interpretations made by artificial intelligence models.

FIGS. 4A-4D are examples of user interfaces showing how operations determined from output of an AI/ML model can be used to specify data processing.

FIG. 5 is an example of a chatbot interface that shows alternative interpretations.

Like reference numbers and designations in the various drawings indicate like elements.

### DETAILED DESCRIPTION

In some implementations, a computer system facilitates the use of artificial intelligence or machine learning (AI/ML) tools and can assist users by showing the interpretations used by AI/ML models. For example, the system can enhance AI/ML chatbots by providing information specifying the interpretations used by the chatbot in generating a response. This provides users context and background information that helps them better understand how their questions are perceived and which data objects were used in generating responses of chatbots. In addition, providing the chatbot's interpretation provides additional transparency about the data sources and data processing underlying the chatbot's response. When the chatbot's interpretation matches what the user expects, the user can have greater confidence in the content of the response. When the chatbot's interpretation is different from what the user expects, the user can more easily detect the difference and instruct the chatbot to make changes and try again.

One way that the system and provide an interpretation is by clearly articulating or restating the user's prompt to indicate how the AI/ML model has interpreted the user's question. In particular, the restatement can specify the types of data used and the relationships between them, and can indicate the logic and criteria of the user's original query. For example, the restatement can show a complete set of criteria for selecting or calculating the results the user requested. This restatement aims to eliminate ambiguities and present the query in its most straightforward form. As an example, a user may enter a prompt such as “Show the top 5 performing employees in terms of sales,” and this can be interpreted as: “Top five employees ranked by sales performance, sorted in descending order.” This approach ensures users understand which metrics are chosen to answer the prompt and shows how the prompt is processed. For example, the interpretation shows the types of data objects used (e.g., “employees” representing employee names or identifiers and “sales performance”), with the processing criteria used for sorting and ranking. Unlike a simple summary, which may omits criteria data types used or criteria applied, the interpretation statement can be a restatement or description of the data processing instructions (e.g., a structured query language (SQL) statement) used to generate the results that the chatbot used to provide its response.

The system can determine the interpretations of the chatbot for each user prompt based on code or instructions that an AI/ML model generates to retrieve data from a data source and/or calculate a result used in responding to the prompt. The system can facilitate this by using multiple interactions with the AI/ML model to answer each user prompt. For example, after a user prompt is received, a first interaction with the AI/ML model can be used to obtain data retrieval code or instructions, such as a SQL statement, that the AI/ML model generates. The data retrieval code or instructions can indicate, in a programming language or other standardized format, the operations or criteria for another system, such as a database system, to apply to retrieve the data that would be used in answering the prompt. The system can analyze the code or instructions generated by the AI/ML model to identify which portions (e.g., columns, rows, tables, etc.) of a source data set are referenced and how those portions relate to the terms in the user prompt. The AI/ML model can also be used to generate natural language text that concisely describes the data and operations represented in the code or instructions. The system can also use the generated code or instructions to retrieve or calculate the values that are needed to answer the user prompt. The system can then provide those values to the AI/ML model and request the answer to the original user prompt, which in many cases include a summary of or analysis of the results that the database system provided based on the code or instructions that the AI/ML model provided earlier.

Operating an AI/ML chatbot or other AI/ML-enabled application with multiple stages of interactions with AI/ML models can provide a number of advantages and benefits. For example, by using the AI/ML model to produce code or instructions, e.g., SQL content, the system obtains clear insight into the interpretation of the AI/ML model of the natural language content of the user's prompt. In addition, by requesting a response with a structured or standardized format, such as SQL content, the interpretations of the chatbot are well-defined and have much less ambiguity than a natural language chatbot response would often provide. When making the request to the AI/ML model, the system can provide the chatbot a data model or data schema for the data source(s) from which to retrieve data. The resulting code or instructions can thus reference specific data objects (e.g., particular logical data objects such as metrics, attributes, facts, etc., which may correspond to data sets, data tables, columns, rows, fields, etc. included in or derived from an underlying data set) with particularity, which can often show a distinct mapping or correspondence to a discrete portion of a data set. In addition, with the code and instructions generated by the AI/ML model, the system can retrieve and calculate values that are often much more accurate than if the AI/ML model attempted to provide the values.

The system can identify and provide many different types of interpretations of AI/ML models to users. For example, the system can provide information that indicates which data element(s) from a data source are selected or mapped to represent terms or phrases in the user's prompt or request. As an example, when processing a user prompt “show me stores with top sales this year from our sales data,” the system can detect that the AI/ML model interpreted “our sales data” to refer to a particular attribute or metric available from a data table in a database, the AI/ML model interpreted “stores” to be values of a store identifier attribute, and the AI/ML model interpreted “sales” to be amounts of gross revenue represented as a particular fact or metric. The system can also provide information that indicates the types of calculations used to generate results (e.g., functions, equations, expressions, algorithms, operations, or procedures used to generate or calculate results). For example, a user prompt may request and/or a chatbot response may include a result that is derived from a source data set but is not included directly in the data set. This may include values that aggregate data across rows of a table (or across tables or other data elements), values that are calculated based on values from multiple columns, values that are selected or filtered according to some criteria, or are otherwise the result of manipulating data. As a result, if the result involves a metric that is a calculated from a data set, the system show the user how the metric is defined, potentially with an equation or expression that indicates the operations that the AI/ML model selected for obtaining the values for the metric. The system can provide other types of interpretations also, such as a semantic meaning for a term or phrase or a selected meaning for a term if there are multiple possible meanings. In some cases, if the interpretation of a term is selected from a knowledge base, or if there are competing definitions or interpretations from different sources, the system can indicate the selected interpretation and its source.

The computer system can support interactive applications where processing tasks for responding to a user prompt are split between non-AI/ML or non-probabilistic data processing systems (e.g., database management systems) and AI/ML models. For example, when a user prompt such as a natural language query is received, the computer system can use a database system to generate a set of result data that is relevant to the user prompt. The set of result data can then be processed using one or more AI/ML models, such as a large language model, to generate content to present in a response to the user. This system can combine the strengths of AI/ML models and non-AI/ML processing systems to provide a chatbot or other application with responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. In some cases, AI/ML models provide content that includes hallucinations or other information that may be statistically plausible given training data but is actually factually incorrect. The probabilistic nature of AI/ML models can also result in the same user prompt resulting in significantly different responses at different times, which can decrease users' confidence and ability to rely on the responses. For example, the same question may yield different numerical answers when the question is asked multiple times to an AI/ML model, even when the source data set has not changed.

As discussed further below, the computer system can provide chatbots and other interactive applications that combine the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data.

When the interactive application is used to respond to a user prompt, the non-AI/ML data processing system (e.g., a database management system) generates result data relevant to the user prompt (e.g., user's question) from the source data set. The user prompt and the result data set, potentially with other information and context, can be provided to the AI/ML model to generate text output for the response to the user. For example, the computer system can send a request for the AI/ML model to summarize the result data set or to generate a response to the original user prompt from the result data set that has been generated. As a result, the text that the AI/ML model generates can draw from values calculated accurately from the source data set, without requiring the AI/ML model to be capable of generating those values itself or without the AI/ML model even accessing the data set. As a result, the output to the user combines the reliable, accurate calculations from the non-AI/ML system with the text and other information provided by the AI/ML model from the result data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata describing the general contents and/or structure of the data set (e.g., types of metrics and attributes, semantic meaning of the columns, etc.) and potentially sample data (e.g., fictitious examples that illustrate the type of content in the dataset without revealing the actual values and records). In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying. After the data processing system performs processing to generate a result data set, the AI/ML model is provided the result data set and asked to generate a summary. In this interaction, the AI/ML model receives the result data set that generally includes aggregated or composite information specifically answering the user's question, and the AI/ML model does not receive access to the underlying dataset itself. As a result, the system avoids granting the AI/ML model—and any third-party providing the AI/ML model as a service—access to portions of the dataset that are not appropriate for answering the current question.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers to customize their chatbots. With the system performing discrete operations leveraging AI/ML models, separate from the core querying of an enterprise's proprietary datasets, the chatbots can be more easily integrated with the processing capabilities of third-party systems.

In some implementations, a computer system includes features to present users with interpretations made by AI/ML models. For example, the system can reveal execution steps for handling user requests to a chatbot or other AI/ML functionality. By determining the interpretations made by AI/ML models and showing users the interpretations, the system can demystify AI/ML decision-making processes and foster user trust. The system can be implemented to provide users with a clear and concise view of how their questions are interpreted, processed, and answered by AI systems.

In some implementations, the interpretation information provided to users is adapted to or is customed for the needs of different users or user groups. For example, a concise, simplified view can be provided for some classes of users, such as those with limited privileges (e.g., read access or view access only) for accessing a document, data set, or application. A more detailed view can be provided for users with greater privileges (e.g., users with read and write access).

One way that the system and provide an interpretation is by clearly articulating or restating the user's prompt to reflect how the AI/ML model has interpreted the user's question. This type of interpretation is very helpful for business users, new users, or those with limited privileges (e.g., read only access), who may appreciate a natural language description. This type of restatement or summary can affirm the logic and criteria used to generate the response. This restatement aims to eliminate ambiguities and present the query in its most straightforward form. The system can be implemented so that if a user copies and pastes the reinterpretation of the user query back into the chat, the AI/ML chatbot will produce the same or extremely similar results, thereby demonstrating the consistency and reliability of the AI's understanding. As an example, a user may enter a prompt such as “Show the top 5 performing employees in terms of sales,” and this can be interpreted as: “Top five employees ranked by sales performance, sorted in descending order.” This approach ensures users understand which metrics are chosen to answer the prompt and shows how the prompt is processed. The system can generate this type of interpretation by extracting information from code or instructions (e.g., SQL content) generated by an AI/ML model. In some implementations, the AI/ML model can be used to generate this summary or restatement. For example, the system can ask the AI/ML model to provide a concise description of the AI/ML model's interpretation of the user prompt or a concise description of the SQL the AI/ML model generated based on the user prompt.

The system can also provide more detailed insights about the execution of data processing operations used to answer the user's prompt to an AI/ML chatbot. For example, for power users with sufficient privileges (e.g., edit privileges for a document or dashboard) such as data analysts, data architects, and IT professionals, the system can offer in-depth insights into the interpretations made by AI/ML models and used in constructing visualizations. These interpretations can include mappings of data objects used, placed under the text restatement of the user's prompt. This can include displaying filtering conditions, attributes, metrics, derived objects, sorting operations, and advanced analytics steps used in the process of generating the final response from the chatbot, enhancing transparency for those who need to validate and fine-tune AI responses. For example, the system can indicate data objects used (e.g., data tables, columns, rows, etc.) and how the data objects correspond to terms or phrases in the user prompt.

In many cases, generating a chatbot response involves multiple stages of processing or includes intermediate steps or data before arriving at the final response. For example, an AI/ML model may generate a SQL statement that generates one or more intermediate tables or sets of results that are then further processed to obtain the final results. These intermediate results are usually hidden and not shown to users, but the system can store them and make them available to users to show the processing steps used to reach the final chatbot response. In some implementations, the system may use a module that generates hidden visualizations for intermediate results, and those visualizations (and/or the data that would be represented in those visualizations) can be made available to users.

Additionally, a discrete icon can be provided available, enabling power users to access and copy the code or instructions from the AI/ML model, which can be in the form of an SQL statement generated by a LLM. As discussed further below, a chatbot or other application can be structured to first request generation of code or instructions for retrieving and processing data, and then the code or instructions can be executed or used to generate the data from a data retrieval system, such as a database management system. Providing users access to the code or instructions generated by an AI/ML model is particularly useful for validation and troubleshooting purposes, allowing power users to determine if discrepancies in responses stem from the LLM's SQL generation or the subsequent visualization construction process performed by other software modules.

As an example, a user may provide a prompt such as “What are the Revenue, Profit, & Profit Margin for every Category, Subcategory in the last 2 years for the Region that have Cost more than $100?” The system can indicate the interpretation of the prompt by indicating the objects in a data set that are selected to represent the items the user mentioned. For example, based on output of the AI/ML model, such as a SQL statement or a request for the AI/ML model to specify the data objects used, the system can determine and show that (1) attributes used include a ‘category’ and a, (2) metrics used include quantities revenue, profit, and profit margin, (3) applied filters include ‘Year: 2021, 2022’ and ‘Cost>100.’ These objects can be identified and displayed to the user so the user can validate and understand the AI's logic in processing the user's prompt.

In some implementations, the system provides user interface controls with or as part of the chatbot response display, for users to provide feedback about the interpretations made and shown. For example, a thumbs up and/or thumbs down icon can be provided, so the user can signal whether the interpretation matched the user's intent when writing the user prompt. Incorporating AI interpretation and execution insights alongside the user feedback mechanism significantly enhances the effectiveness. It is particularly valuable when users give negative feedback, e.g., a thumbs down rating. The feedback and context can be saved and provided to authors of documents and chatbots, so authors can see the user's question and the AI/ML model's interpretation. This insight is very helpful for pinpointing misunderstandings or inaccuracies and taking targeted steps to enhance the system's responses and accuracy.

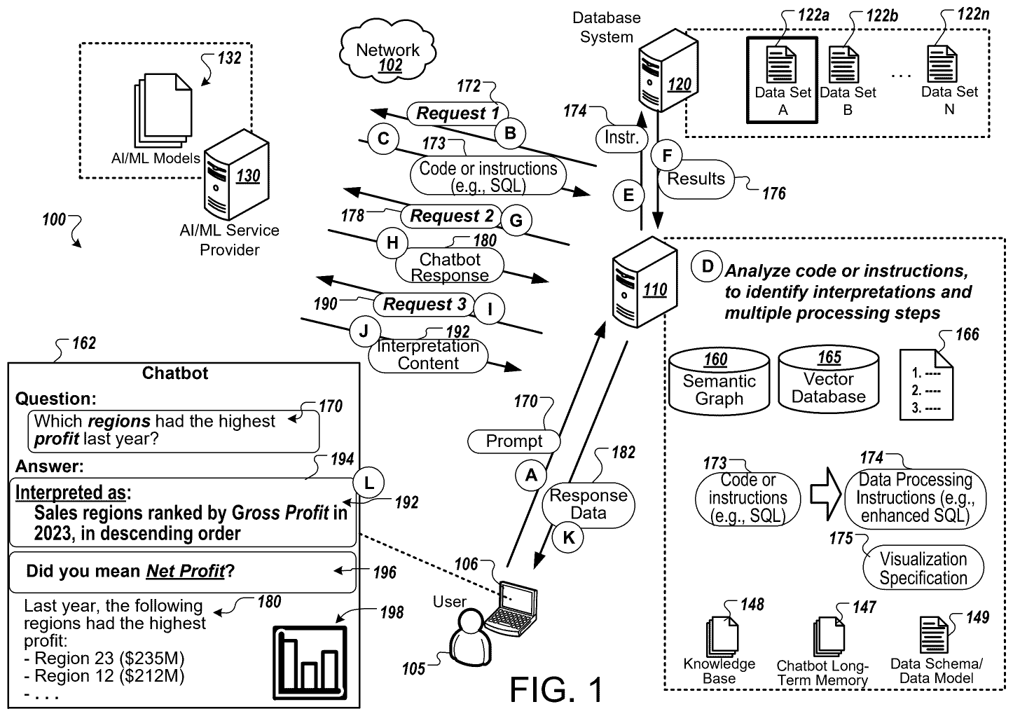

FIG. 1 is a diagram showing an example of a system 100 for determining and revealing interpretations made by artificial intelligence models. The system 100 includes a computer system 110, a database system 120, and an AI/ML service provider 130. The system also includes a user device 106 of a user 105. The elements of the system 100 communicate over a network 102, such as the Internet. The computer system 110 coordinates a variety of operations to provide and manage access to chatbots and other AI/ML applications. In the example, the user 105 enters a user prompt 170 for a chatbot, and the computer system 110 coordinates the generation of the answer by the chatbot, including a text response 180 generated by an AI/ML model 132, a data visualization 198, and accompanying interpretation information 194 that indicates how the AI/ML model 132 interpreted the user's prompt 170. The example of FIG. 1 includes stages (A) to (K), which represent various operations and a flow of data, and which can occur in the order illustrated or in a different order.

The computer system 110 can produce chatbot answers with high accuracy and high reliability by generating the chatbot's response to the prompt 170 using multiple interactions with the AI/ML model 132. For example, the computer system 110 sends a first request 172 that requests that the AI/ML model 132 generate code or instructions 173 for retrieving and/or calculating values for answering the prompt 170. The first request 172 can request that the response be provided in a standardized format, such as structured query language (SQL) or another programming language. The computer system 110 then uses the code or instructions 173 (or a modified version shown as data processing instructions 174) to retrieve results 176 from one or more data sets of the database system 120. The computer system 110 can then send the results 176 from the database system 120 to the AI/ML model 132 in a second request 178 to generate a response (e.g., a chatbot text response) to the prompt 170 that is based on the results 176. The computer system 110 can send a third request 190 to the AI/ML model 132 that requests a text statement of the interpretation of the prompt 170 and/or the operations or criteria used to respond to the prompt 170. For example, the third request 190 can be a request for the AI/ML model 132 to generate a concise natural language description of the data processing instructions 174 (e.g., a SQL statement) used to generate the results 176. In this manner, an LLM or similar model can be used to translate from code or instructions for retrieving data to a user-readable text statement of the criteria or operations used to generate the results 176 from the database system 120 used in providing the chatbot's response.

The computer system 110 can be implemented using one or more servers, such as one or more cloud computing systems, one or more on-premises servers, etc. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface. The computer system 110 performs various other functions to generate and save customized chatbots, to manage and grant access to existing chatbots, and to coordinate the processing of user prompts to generate responses from the chatbots.

The database system 120 can provide various data retrieval and processing functions. For example, the database system 120 can be a database management system (DBMS), and can include the capability to process operations specified in structured query language (SQL), Python code, or in other forms. The database system 120 has access to various datasets 122a-122n, which can be private datasets for organization, such as a company. The database system 120 can store and use datasets in any of various forms such as tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

Chatbots can be provided by the computer system 110 or other systems, including third-party systems. Some or all of the chatbots may be executed or managed by the same server system or same operator as the computer system 110. Each chatbot can have an associated dataset 122a-122n (or multiple datasets) from which the chatbot derives responses to user. Each chatbot can also have a corresponding AI/ML model 132 designated to use for generating responses from the chatbot, such as a LLM. Each chatbot can also have a corresponding set of settings and customizations that specify various properties of the chatbot (e.g., text output tone and style, output format, verbosity, etc.). Different chatbots may use different datasets 122a-122n or share the same datasets 122a-122n, and similarly different chatbots may use different AI/ML models 132 or share the same AI/ML model 132. Each chatbot can also include functionality to store conversation histories for each user across different sessions of use. In other words, for the user 105, each chatbot can store a separate, persistent chat history for the interactions of the user 105.

Different users have access to different datasets 122a-122n and chatbots 108a-108n, depending on their roles, permissions, etc. The user 105 authenticates to the computer system 110, so that the user's identity is determined and the user's permissions can be determined.

In the example of FIG. 1A, in stage (A), a user 105 enters a prompt 170 in a chat user interface 162, and the client device 106 of the user 105 sends the user prompt 170 to the computer system 110 over the network 102. The user 105 accesses a chat user interface 162 for interacting with AI/ML chatbots using a user device 106 (e.g., a phone, a laptop computer, a desktop computer, etc.). For example, the chat interface 162 can be part of a web page, a web application, a native application on the user device 106. The chat interface 107 can be displayed based on user interface data provided by the computer system 110 or another server. The user 105 interacts with the chat interface 107 to enter a user prompt 111, which in this example is the question, “What is the typical response time for new technical support tickets?” The user 105 has previously been authorized to access multiple chatbots, in this case, all of the chatbots 108a-108n. Before submitting the user prompt 111, the user 105 has logged in and authenticated, so the computer system 110 is aware of the identity of the user 105 and can grant and limit access based on the user's permissions.

Various techniques can be used to identify one or more data sets 122a-122n that are relevant to the prompt 170. In some implementations, the chatbot that the user 105 converses with has a specific set of one or more data sets 122a-122n associated with it, and these data sets can be identified to the computer system 110 or be pre-associated with the particular chatbot. In some implementations, the chatbot interface 162 can be integrated with or provided alongside another interface region, such as a viewing area displaying a document, dashboard, or other content. The data set 122a-122n used to respond can vary based on the document or content that is active (e.g., being viewed, edited, etc.). For example, one or more data sets 122a-122n that are relevant to the user's current context can be identified based on the document or other content being displayed, so that if a document section being viewed includes content derived from a particular data set 122a, that data set is identified and indicated to the computer system 110. In some implementations, the relevant data set(s) 122a-122n are indicated earlier in the conversation history or are explicitly set by a user interacting with a user interface control. In some implementations, the computer system 110 itself selects which data sets to use, from among different data sets 122a-122n, based on access permissions of the user 105 and/or the topics or keywords in the prompt 170.

In stage (B), the computer system 110 generates and sends a first request 172 to the AI/ML service provider 130 based on the prompt 170. The first request 172 can be a request for an AI/ML model 132 to generate data processing code or instructions, e.g., a request for an LLM to generate a SQL statement or other criteria for retrieving and/or generating data from a data set. The first request 172 can include some or all of the prompt 170. The first request 172 can also include information about the types of data available in the data set 122a, such as a data model 149 or data schema for the data set 122a.

The computer system 110 can also include in the request 172 request for the LLM to provide, in addition to its primary interpretation of elements of the prompt 170 as used in the requested data processing code or instructions, alternative interpretations that are likely. For example, the request 172 can ask for the LLM to provide lists of interpretations used, ranked by the LLM according to which interpretation is most likely. In some implementations, the request 172 can ask for the interpretations to be assigned scores 166 or other ratings by the LLM, with the scores 166 indicating the LLM's estimate of the suitability or likelihood that the interpretations are accurate. In some implementations, the request 172 can ask for interpretations to be selected from or mapped to data objects from among the set of logical objects indicated in the data model for the data set 122a. As a result, the interpretations that the LLM provides can be selections of attributes or metrics from the data set 122a, or values derived from those attributes or metrics.

The first request 172 can be a request for an AI/ML model 132, such as an LLM, to generate code or instructions for a system (such as the database system 120) to use in retrieving and/or generating data to answer the prompt 170. For example, rather than asking the AI/ML model 132 to generate the answer to the prompt 170, the first request 172 can request a SQL statement, programming code, a list of operations, or other instructions that specify criteria that would retrieve and/or calculate the values needed to answer to the prompt 170. As a simple example, the prompt to the LLM in the first request 172 may include an instruction such as “provide a SQL statement that retrieves the data needed to answer the question <<user prompt>>,” or “generate Python code that can run on <<database system>> to calculate the answer to the question <<user prompt>>.”

In the example of FIG. 1, the relevant data set 122a for the chatbot conversation is “Data Set A,” illustrated as data set 122a. In response to the prompt 170, the computer system 110 generates the request 172 to include text instructions to an LLM such as, “Generate a SQL statement to retrieve from Data Set A the data that answers ‘Which regions had the highest profit last year?’” As a result, the first request 172 can be a request for a SQL statement or Python code that, when interpreted or executed by another system such as the database system 120, that specify the criteria for the other system to retrieve and/or generate values (e.g., a result data set) derived from a data set 122a-122n that can provide the information needed to answer to the prompt 170.

By requesting code or instructions, the process takes advantage of the ability of AI/ML models 132 to reliably produce high-quality code or instructions expressed in programming languages (e.g., SQL, Python, Java, HTML, XML, etc.). This often generates in a more concise and unambiguous result than more free-form text outputs. This type of request guides or constrains the AI/ML model 132 to follow the conventions of a particular programming language (which can be specified in the request 172). Programming languages are usually designed to avoid ambiguity and to promote consistency in usage of terms across many different situations. As a result, code examples often demonstrate clear usage patterns that the AI/ML models 132 can learn from and follow.

Also, by requesting that the AI/ML model 132 create the code or instructions using a standardized format, such as SQL, this greatly increases the number of different AI/ML models 132 that can be used with the system. For examples, many different LLMs may have a capability to create SQL, while models, if any, may be able to reliably generate visualizations or descriptions of visualizations. With many different options for selecting an AI/ML model 132 to create SQL, the computer system 110 has the versatility to vary which AI/ML service provider or model is used (e.g., for cost, speed, load balancing, etc.) and the robustness to change which model is used if a AI/ML service provider or model becomes unavailable.

Requesting that the AI/ML model 132 create code or instructions for data retrieval takes advantage of strengths of LLMs, such as natural language interpretation of the user's prompt 170 and ability to generate text, such as code, that follows established patterns or rules. This also constrains the constrains the form of the output to a set of code or instructions, such as SQL or another standardized representation, which allows the high-quality results to be achieved reliably.

To enable the AI/ML model 132 to reference the appropriate logical data objects of the relevant data set 122a (“Data Set A”), the first request 172 includes the data model 149 for the data set 122a to be used. The data model 149 can include information about the data set(s) that the chatbot will use to respond to the request 172, usually without providing any of the actual content of the data set. For example, the data model 149 can include a data schema for the data set 122a. In general, the data model 149 can indicate a list of logical objects represented in the data set 122a, such as a list of the elements or components of the data set, such as metrics, attributes, facts, and so on. For example, the data model 149 can indicate that the data set 122a includes logical objects such as date, customer identifier, region code, sales amount, and so on. These data objects can represent quantities or data objects that are represented in, or can be derived from, data in the data set 122a. The logical objects, such as metrics or attributes, can represent the type of data that is stored in or derived from a column of data. For example, an attribute may represent a type of data stored in a column of a data table or the result that would be obtained by applying a particular arithmetic expression to data in a column. Similarly, a metric or fact can represent the result of applying a particular aggregation function or other operation(s) to values in one or more columns of a data table. Accordingly, the data model 149 can indicate the attributes and metrics that are available for the AI/ML model 132 to work with, and potentially additional attributes or metrics that can be generated or operations that are available for the database system 120 to create a new attributes or metrics.

In some cases, the data model 149 can indicate, through the logical objects identified, data from tables, columns, and other elements that make up the data set 122a, in addition to or instead of the semantic meanings and/or relationships among these elements of the data set 122a. For example, the data model 149 can indicate that the data set 122a includes set of data named “sales_table,” that includes a metric named “sales_amount” that indicates amounts of sales and another attribute named “region” that indicates the region in which the sale occurred. These quantities may or may not correspond directly to the structure of the data set 122a. For example, the item “sales_table” may be an actual data table of a database, or may not represent a table and instead another grouping of data. Similarly, the “sales_amount” and “region” objects may correspond to specific columns of a data table, but may alternatively represent values that can be calculated or otherwise derived from the data set 122a in another way. Providing the data model 149 can give the AI/ML model 132 a list and description of the logical objects that the database system 120 recognizes, so that code or instructions generated by the AI/ML model 132 can use the identifiers known to the database system 120 and/or the computer system 110. As a result, the AI/ML model 132 can generate code or instructions that reference these logical objects that are understood by the computer system 110 and the database system 120. To the extent that the objects indicated in the data model 149 differ from the actual structure of the data set 122a, the computer system 110 and the database system 120 can use convert from the logical object names used in the data model 149 to actual data set elements and functions.

The data model 149 can indicate the names or labels for these data elements, classifications of the elements (e.g., metric, attribute, etc.), and other information. In some implementations, the data model 149 can include sample data for the data set 122a, such as a sampling of data from the data set 122a. The sample data can be fictitious example data that may be artificially synthesized to be representative of the data in the data set 122a (e.g., similar types of data), without indicating actual contents of the data set 122a. The data model 149 can be provided in any of various forms, such as a database schema from a database management system, a list or definitions of objects, components, or identifiers of the data set 122a, etc.

By providing the data model 149 with the request 172, the computer system 110 provides the AI/ML model 132 the ability to make use of the logical objects specified in the data model 149. As a result, the AI/ML model 132 can determine the types of data that would be available from the data set 122a, even without the AI/ML model 132 having any access to the data set 122a. The AI/ML model 132 can generate code or instructions (e.g., a SQL statement) that references these logical objects, with a clear set of names or other identifiers to accurately and unambiguously reference components of the data set 122a. For example, providing the data model 149 for the data set 122a, may enable the AI/ML model 132 to reference logical objects in generated SQL statements that the computer system 110 and/or database system 120 can unambiguously map the logical objects to tables and columns of the data set 122a. This allows the AI/ML model 132 to distinctly and unambiguously define criteria to specify the subset or portion of data to be retrieved from, or calculated based on, the data set 122a.

In some implementations, the first request 172 includes additional information that assist the AI/ML model 132 to interpret and respond to the user prompt 170 and other information, such as a knowledge base 148. The knowledge base 148 can provide a mapping for the AI/ML model 132 to map words and phrases with non-standard or idiosyncratic meanings (e.g., jargon, nicknames, etc.) to definitions, descriptions, or other indications of their meaning. The knowledge base 148 can include information determined at any of multiple levels, such as at the level of an enterprise as a whole, for a department or group of individuals, or for a specific individual. Similarly, the knowledge base 148 can be one that has been created for a single chatbot or AI/ML application or one that is shared with multiple chatbots or AI/ML applications.

In some implementations, the computer system 110 enables the administrator 103 to attach one or more additional data sets to adjust the operation and output of the chatbot. For example, an additional data set can be a knowledge base 148 or data dictionary can be added. Unlike the primary data set that the user selects for the chatbot (e.g., data set 122a), the chatbot is not configured to answer questions about the additional data set or to retrieve metrics or to provide visualizations of the knowledge base 148. Instead, the knowledge base 148 can be provided to assist the chatbot in interpreting user queries and providing responses with the terminology for the user's organization. In general, the knowledge base 148 can function to provide contextual knowledge to the AI/ML models 132, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base 148 is designated for the chatbot to describe these and other internal terms. Each time the user submits a prompt, the knowledge base 148 can be provided to assist the LLM with the context that is appropriate for the company. The knowledge base 148 can provide information similar to a semantic graph, by describing entities and their relationships. In some cases, the information in the knowledge base 148 can be derived from a semantic graph 150 and then converted into text (e.g., unstructured, semi-structured, or structured) in a format that can be processed by the LLM.

In general, the knowledge base 148 or other additional data set can include data that maps terms or phrases to their meanings. In many cases, this can include semi-structured data or explanatory content, as a way to explain entities and relationships wo the AI/ML models 132. Although the knowledge base 148 may include definitions, more generally the information may include descriptions of people, roles, business units, products, and other terms that may be referenced. The administrator 103 may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases 148 as contextual data sets that can be applied consistently across the enterprise, for all chatbots created and used in the enterprise. Similarly, different departments within the enterprise may add their own particular contextual data sets that may supplement the enterprise-wide knowledge bases 148. In addition, specific contextual data sets can be added for specific chatbots. In this way, chatbots at different levels of an organization can inherit a consistent set of terminology and knowledge in an organization, which also makes maintaining the overall knowledge base much more simple. The knowledge bases 147 can additionally or alternatively be specified with a scope that corresponds to a computing environment, so that chatbots associated with a particular domain or server inherit the knowledge bases for that domain or server.

One of the advantages of the knowledge base 148 is consistency for many users and even for many different chatbots of an organization. The user submitting a prompt does not need to take any action to select or include the knowledge base 148 in the chatbot's processing, the chatbot automatically include the knowledge base 148 in its context for each prompt or question received. Also, because the knowledge base 148 can be shared or inherited by many chatbots within an organization, updating and maintaining the knowledge base 148 is simple. An edit to the knowledge base 148 is automatically applied to all of the chatbots associated with the organization, even if the chatbots were created by different administrators or provided to different sets of users.

In addition, the knowledge base 148 provides persistent context that is not lost from one prompt to another or from one session to another. The knowledge base content can also be implemented applied in a manner that the knowledge base 148 does not count toward the instruction token limits that the AI/ML models 132 consume for each response. Rather than counting toward the tokens for prompts and recent history, the knowledge base 148 can be accessed or provided to the AI/ML models 132 as a separate source of knowledge apart from the prompt and context, and so does not count toward the token limits of an LLM. Implementations of access to the knowledge base 148 can vary. For example, when a session with the chatbot is instantiated, the knowledge base can be provided as part of initializing the chatbot. In some cases, the AI/ML models 132 are additionally or alternatively configured to access the primary dataset and if the user prompt includes a term or makes a request for an item not specified in the primary dataset, the chatbot is configured for the AI/ML models 132 to then check the knowledge base or other contextual data sets. In some implementations, the knowledge base 148 can be prepared as an embedding, a vector database, or other format that can be accessed by or referred to by the AI/ML models 132.

The first request 172 can include additional information such as a conversation history for the user 105 and the chatbot, and/or a long-term memory 147 with information that persists across chat sessions. The history or memory 147 can represent any of various types of information that can be stored external to the AI/ML models 132 but captures information about previous sessions, previous conversations or previous text of the current conversation, preferences of one or more users, learning from feedback of one or more users, and so on. In some implementations, the chatbot is designed to have a long-term memory 147, which can store information learned from users in past interactions. For example, LLMs and other AI/ML models 132, on their own, are generally stateless and do not natively understand the user context or history of interactions with the user, especially from previous sessions. The computer system 110 can facilitate learning by the chatbot to provide infrastructure that creates a long-term memory 147 for the chatbot. For example, the long-term memory 147 can store items such as definitions of terms for a particular user context, unique text elements the chatbot might encounter, and feedback from prior user interactions.

One valuable aspect of the long-term memory 147 is the ability for the chatbot to learn and adapt from explicit or implicit user feedback over time. If a user asks questions, then gives feedback they were expecting something different (e.g., either through text of a prompt to the chatbot or through an external survey or rating), then the computer system 110 can capture that feedback and update the chatbot to better provide what the user intended in the future. For example, the computer system 110 may add or adjust the instructions to the chatbot to reflect the user expectations or preferences. In some cases, this may include changing the default response format or response instructions, or may include adding rules or explanations that are context-dependent (e.g., apply to specific phrases or prompt types). This learning may occur at different levels. For example, it may include learning that particular terms, phrases, or combinations of terms call for a particular type of response. As another example, the feedback may more shift answers generally in certain ways, e.g., to be more verbose, more concise, to add or change visualizations, to change the order of content, to add or adjust summary elements, and so on.

In stage (C), the AI/ML service provider 130 uses one or more of the AI/ML models 132 to generate a response to the first request 172. The AI/ML service provider 130 then sends the response, code or instructions 173, to the computer system 110. As discussed above, the first request 172 requests code or instructions specifying the criteria or data processing operations that can be used to retrieve and/or generate (e.g., calculate) from the data set 122a the result data that would be needed to answer the user prompt 170.

The response from the AI/ML service provider 130 can also include a list of interpretations for one or more portions of the prompt 170. For example, the AI/ML service provider 130 can provide a list of attributes of the data set 122a that an LLM predicted to be the best interpretations for “regions” in the prompt, ranked or scored to show the relative confidence or likelihood of correctness of each potential interpretation (e.g., level of match or similarity to the concept of “regions” as used in the prompt). Similarly, the AI/ML service provider 130 can provide a list of metric of the data set 122a, or derived from the data set 122a through an equation or other expression, that an LLM predicted to be the best interpretations for “profit” in the prompt, ranked or scored. Because the LLM receive context information of the data model 149 for the relevant data set 122a, as well as context information such as a knowledge base 148, previous contents of the current chat conversation or previous conversations, and so on, the LLM can often identify and evaluate the potential interpretations of the prompt 170 in the proper context.

In response to the request 172, the AI/ML service provider 130 uses the AI/ML models 132 to generate the code or instructions 173 that specify the criteria to retrieve and/or generate the data needed to answer the prompt 170. This part of the process leverages the ability of the AI/ML models 132, e.g., LLMs, to generate a set or sequence of instructions or operations. The data processing instructions 174 can be expressed in any of a variety of ways, such as one or more SQL statements, as executable or interpretable code, such as Python code, as a list of API calls or commands to be executed, and so on. The code or instructions 173 can provide instructions for retrieving specific portions of one or more data sets, such as from the specific data set 122a specified in the prompt 170 or otherwise indicated to the AI/ML model 132 used. The code or instructions 173 can additionally or alternatively instruct various data processing steps or operations to be performed, including data joins, data aggregations, filtering data, evaluating expressions, creating new metrics and calculating their values, etc.

As an example, in response to a request 172 that included an instruction, “Generate a SQL statement to retrieve from Data Set A the data that answers ‘Which regions had the highest profit last year?,’” the code or instructions 173 generated by the AI/ML model 132 can be a SQL statement such as the one below:

```
WITH Profit_Calculation AS (
  SELECT region_name, SUM(sales_amount − costs) AS total_profit
  FROM Data_Set_A
  WHERE YEAR(date_attribute) = YEAR(CURRENT_DATE) − 1
  GROUP BY region_name
)
SELECT region_name, total_profit
FROM Profit_Calculation
ORDER BY total_profit DESC
LIMIT 10;
```

In this example, the generated SQL statement can refer to logical data objects, which may or may not correspond to actual columns of data stored in the data set 122a. Based on the data model 149 and the logical objects it specifies to be available (and those that are omitted), the AI/ML model 132 generates output that refers to the object “date_attribute” indicating the date of entries, the object “region_name” which indicates the names of the regions, an object “sales_amount” that indicates sales amounts, and “costs” that indicates costs. Because the data model 149 does not indicate that the data set 122a includes a “profit” object, the generated SQL statement specifies to calculate profit values from the “sales_amount” and “costs” object and give the result the label “total_profit.”

In stage (D), the computer system 110 analyzes the code or instructions 173 from the AI/ML service provider 130 to identify interpretations used and detect when multiple processing steps (e.g., multi-pass SQL statements) are used. This can include using the code or instructions 173 generated by the AI/ML model 132 to generate data processing instructions 174 to be processed by the database system 120. For example, the computer system 110 can analyze and update the code or instructions 173, such to modify the SQL statement from the AI/ML model 132 to an enhanced or improved SQL statement. As a result, the data processing instructions 174 can be a combination of code or instructions 173 from an AI/ML model 132 and changes or enhancements added by the computer system 110. As discussed below, the computer system 110 can also infer or extract, from the code or instructions 173, the interpretations made by the AI/ML model 132, as well as identify and evaluate alternative interpretations.

In some implementations, the computer system 110 examines the code or instructions 173, such as to verify or edit the code or instructions 173 as needed for compatibility or efficient processing by the database system 120. In some cases, the standardized format of the code or instructions 173 allows it to be provided directly to the database system 120 for execution or processing. In other cases, the data retrieval manager 144 may alter the code or instructions 173 or translate the code or instructions 173 to another form. For example, the data retrieval manager 144 can translate a generalized or standardized set of code, such as a SQL statement, into a more specialized or targeted form of data processing instructions 174 that makes use of the specific features of the database system 120. For example, the generated data processing instructions 174 can reference functions, commands, modules, application programming interfaces (APIs), or other features of that database system 120 that may go beyond or may not be supported in the more standardized code or instructions 173.

As another example, although the AI/ML model 132 has the data model 149 for the data set 122a in its context when processing the request 172, the resulting code or instructions 173 may include errors, such as incorrect identifiers for attributes, metrics, data sources, or other references to the data set 122a. The computer system 110 can examine and validate the code or instructions 173 to identify and correct errors in the syntax or structure of the SQL statement or other content present, and similarly update references to the data set 122a to generate a set of data processing instructions 174 that can be executed correctly by the database system 120. For example, the computer system 110 may apply a set of rules or validation checks to verify that the code or instructions 173 are valid and appropriate to be executed by the database system 120. For example, the computer system 110 can store rules or heuristics that can evaluate the data processing instructions 174 element by element and/or as a whole to verify and correct the code or instructions 173 if needed before they are sent to the database system 120.

The computer system 110 can analyze the code or instructions 173 that the AI/ML model 132 generates to identify when multiple stages of data processing are needed, such as a SQL statement that involves multiple passes or the creation of multiple tables. For example, the computer system 110 examines the code or instructions 173 and determines whether multiple steps or stages of processing are called for. For example, the computer system 110 can identify features of SQL commands and syntax that show that multiple passes or stages are used, such as the presence of two “SELECT” commands indicating two data retrieval operations, the presence of a “JOIN” command to indicate joining of two tables or data sets, the grouping of a set of commands nested in parentheses, and/or the labeling of a retrieved subset of data as a temporary table or other data structure created and used later to generate the final output. These aspects and/or other keywords, phrases, patterns, syntax, structure, or other features can be detected by the computer system 110 to detect the presence of multiple stages of data retrieval and data processing, as well as to separate out the different processing steps.

In some implementations, the computer system 110 creates a table and/or visualization for each step or stage of data processing indicated by the code or instructions 173. For example, by creating and storing a temporary table and temporary visualization for each stage, as an intermediate processing step, the computer system 110 may leverage existing procedures and software modules that are configured to create a table and visualization for a single stage. In addition, having intermediate tables and/or visualizations for the components of the final visualization can be useful to show the user 105 how the prompt 170 was interpreted and how the system arrived at the data in the final visualization. Temporary tables and temporary visualizations for intermediate steps may be hidden from the user, at least initially, and then can be made available if a user requests to view them or enables a view of them (e.g., by clicking a user interface control to show a hidden region, to expand a user interface panel, etc.).

In some implementations, the computer system 110 can also evaluate the interpretations that are available for portions of or all of a user's question to detect ambiguity or the availability of multiple interpretations. As discussed above, the response from the AI/ML model 132 to the first request 172 can list interpretations for one or more portions of the prompt 170, as well as a ranking or set of scores 166 for the interpretations.

The computer system 110 can identify interpretations in other ways in addition or as an alternative. For example, the computer system 110 can identify when terms in a users prompt to a chatbot may potentially correspond with multiple different data objects in a data set, such as different attributes or metrics or different columns in a data table, by comparing user's terms with labels or metadata for the data objects. As another example, the computer system 110 can identify interpretations using a semantic graph 160 that describes objects and connections among them. The computer system 110 can use terms in the prompt 170 to search the semantic graph 160 for potential matches, especially among data objects of the data set 122a or objects connected to the data set 122a.

As another example, the computer system 110 can use a vector database 165 to identify potential interpretations. For example, information describing data objects in the data set 122a, and potentially in other data sets 122b-122n also, can be stored in the vector database 165 by representing the data objects in a vector space. The user prompt 170, or portions (e.g., chunks or phrases) of the user prompt 170, can also be represented in the vector space. Then, the computer system 110 can determine which of the other objects from the vector database 165 are closest to the vectors of the user prompt 170. The objects having vectors that are closest to the vectors of the user prompt 170 can be identified as the most similar, and thus represent possible interpretations.

Using these or other techniques, the computer system 110 can detect situations when multiple different interpretations are possible, and the computer system 110 can also score or rank the potential interpretations. For example, the computer system 110 can then use the vector database 165 to assess the similarity of a vector representation of a user's prompt 170, or portions of the prompt 170, with the vector representations of the potential interpretations identified (e.g., data objects, terms, concepts or other items represented in the vector database). The distance between the vector(s) from the user's prompt 170 with the vectors of items in the vector database 165 can be used to generate a similarity metric or similarity scores 166 indicating the conceptual similarity of the prompt 170 to the items. As another example, the computer system 110 can generate scores 166 for the interpretations using the semantic graph 160, to see how related terms and concepts are with each other, or with objects representing them. As another example, the computer system 110 can use other records, such as usage data, to determine an affinity score or co-occurrence score among various records to determine the similarity or relatedness of terms and data objects, as additional indications of the strength or appropriateness of different interpretations. As discussed below, these scores 166 can be used to determine whether to indicate or point out to the user that an alternative interpretation is available.

In stage (E), the computer system 110 uses the data processing instructions 174 to instruct the database system 120 to obtain (e.g., retrieve, calculate, generate, etc.) the data needed to answer the user prompt 170. For example, the computer system 110 may send a request that includes the data processing instructions 174 to the database system 120, in order to request the needed data.

In stage (F), the database system 120 generates and sends results 176 that include the data retrieved from and/or generated based on applying the data processing instructions 174 for the dataset 122a. The database system 120 processes or executes the data processing instructions 174 that it receives, which creates the results 176, which may be in any of various forms, such as records retrieved, data series, aggregations of data, statistics about data in the dataset 122a, subsets of the dataset 122a determined to be relevant, and so on.

In the illustrated example, the user prompt 170 asks which regions had the highest profit over the last year. The data processing instructions 174 specify the criteria or operations needed to generate measures of profit by region for the previous year. For example, the data processing instructions 174 may include a SQL statement to retrieve these values, or may include a set of instructions in a programming language, such as Python. The results 176 generated by the database system 120 include the values needed to answer the question in the user prompt 170. In other words, the results 176 include values of profit for the regions specified in the dataset 122a, appropriately labeled or associated with identifiers for those regions.

In this process, the AI/ML models 132 have been leveraged to obtain the results 176, however, the AI/ML models 132 did not need or receive access to the dataset 122a itself, and the AI/ML models 132 did not incur the resource costs of having to process the dataset 122a. In addition, the database system 120 and its reliable, repeatable calculations ensure that the results 176 are accurate, without the AI/ML models 132 introducing uncertainty into the calculations. In addition, the dataset 122a may be very large, much larger than the maximum context length of an LLM used for the AI/ML model 132. In many cases, the amount of data in the dataset 122a may be orders of magnitude larger than the maximum context size that the LLM can process. The database system 120 can process a large data set much more quickly and with greater power efficiency than an LLM can. Also, due to limits on LLM context sizes, it may be impractical or impossible for an LLM to analyze the dataset 122a to generate the needed results 176.

In stage (G), the computer system 110 sends a second request 178 to the AI/ML service provider 130. The second request 178 includes the results 176 and requests that the AI/ML models 132 generate a response that answers the prompt 170 based on the results 176. For example, the second request 178 may be a request to answer the prompt 170 using the data in the results 176 as context. As another example, the second request 178 may be a request for the AI/ML models 132 to summarize the results 176, in addition to or instead of answering the user prompt 170.

As with the first request 172, the computer system 110 can provide user context data, a conversation history for the user 105, or other context information in or with the second request 178, so the AI/ML model 132 can generate a response based on the context of the user's situation and the user's previous conversations. The computer system 110 can also provide information from the knowledge base 148, the long-term memory 147, the data model 149, and so on.

In stage (H), the AI/ML service provider 130 uses the AI/ML models 132 to generate a response to the user prompt 170, e.g., a chatbot response 180 that includes natural language text providing the answer to the prompt 170 as determined from the results 176. For example, the second request 178 may include or provide access to the results 176 and the user prompt 170, and so the AI/ML models 132 generate a text response 180 to the prompt 170 from the values in the results 176. For example, in the illustrated example, the chatbot response 180 is text that one or more AI/ML models 132 generated that indicates the specific regions having the highest profit, as requested by the prompt 170, along with an indication of the profit values taken from the results 176.

In stage (I), the computer system 110 generates and sends a third request 190 to the AI/ML service provider 130. The third request 190 asks for the AI/ML model 132 to generate concise natural language text that expresses the operations or criteria used in responding to the user prompt 170. This can be done by providing the code or instructions 173 that the AI/ML model 132 generated based on the prompt 170, and asking for the AI/ML model 132 to concisely summarize or explain the code or instructions 173 that the AI/ML model 132 generated. In other words, the third request 190 can ask the AI/ML model 132 to translate a SQL statement that the AI/ML model 132 itself generated back into a natural language statement that expresses the type of result data that the SQL statement would generate. Thus, the system can use the AI/ML model 132 to interpret the user prompt 170 and convert it to code or instructions 173, and then use the AI/ML model 132 to interpret the code or instructions 173 and convert it to a natural language statement. This two-step process, converting from natural language to SQL then back to natural language, provides an effective way to obtain the interpretation applied by the AI/ML model 132, so it can provide transparency about how response content is generated. The third request 190 can provide guidance or limits for the response, such as to specify that all of the data processing criteria should be included, or to limit the length or form of the response to a single sentence or another specified limit.

The data processing instructions 174 used by the database system 120 to generate the results 176 are based on (e.g., derived from or are edited versions of) the code or instructions 173 from the AI/ML model 132, as discussed above. As a result, the interpretation of the code or instructions 173 can provide a useful description of the criteria used to generate the results 176, which in turn were used by the AI/ML model 132 to generate the chatbot response 180. If a visualization is generated in response to the prompt 170, the visualization is typically generated based on the same results 176. In some implementations, the third request 190 can provide the data processing instructions 174, in addition to or instead of the code or instructions 173, and can ask for a natural language statement describing or summarizing the code or instructions 173 or the data processing instructions 174 used by the database system 120 to generate the results 176.

The third request 190 can request that an AI/ML model 132 generate concise natural language text that expresses the operations or criteria of the code or instructions 173 (or the data processing instructions 174). In other words, the third request 190 can request for the AI/ML model 132 to translate the code or instructions 173, such as a SQL statement, into natural language text. For example, the third request 190 can include an instruction to an LLM, such as “Generate a concise statement that describes the data retrieved by the following SQL statement,” together with the SQL statement used as the data processing instructions 174. As another example, the instructions may be “Explain in a single sentence the type of data that would be generated by the following SQL statement.” Many other instructions or variations of the instructions can be used, and the computer system 110 can be configured to store or generate appropriate instructions statements.

In stage (J), the AI/ML service provider 130 generates interpretation content 192 in response to the third request 190 using an AI/ML model 132 and sends the interpretation content 192 to the computer system 110 over the network 102. For example, as indicated in the request 192, the AI/ML service provider 130 uses an AI/ML model 132 to generate natural language text that expresses the criteria and/or operations in the code or instructions 173 (and/or the data processing instructions 174). In the example, the interpretation content 192 is a statement “Sales regions ranked by gross profit in 2023, in descending order.”

Responding to the third request 190 can cause the AI/ML model 132 to interpret, at least in part, the code or instructions 173 that the model 132 itself generated based on the user prompt 170. For example, after an LLM interpreted the user prompt 170 and translated its criteria to SQL in response to the first request 172, responding to the third request 190 involves translating back from SQL to natural language. The interpretation content 192 shows how the prompt 170 was interpreted, described in terms of the data objects, data processing operations, and criteria used in actually generating the chatbot response 180 and any visualizations provided. If the computer system 110 has modified or enhanced the original code or instructions 173 generated by the AI/ML model 132, those changes can be provided to the AI/ML model 132, so that the data processing instructions 174 that are analyzed when generating the interpretation content 192. As a result, the interpretation content 192 can show an interpretation of a combination of the interpretation of the AI/ML model 132 as well as potential changes or other contributions of the computer system 110 to the data processing criteria. Thus, the translation from SQL back to natural language is done using a SQL statement or other code or instructions that define or describe the criteria and/or operations used to generate the results 176.

The natural language text in the interpretation content 192 can include a complete set of the criteria processed to determine the results 176. The concise statement is not required to mention every logical object or every column of data used in generating the results 176, and so may omit references to items such as table names, join operations, or intermediate results or calculations. Nevertheless, the concise statement can identify the final type of data generated (e.g., profit for sales regions) and criteria such as filters applied, sorting criteria used, and so on. In some implementations, the concise statement in the interpretation content 192 is a complete description of the criteria used to specify what the results 176 represent, so that copying and pasting the natural language concise statement of the data processing criteria to the chatbot allows the data retrieval and calculations to be re-run, allowing the user to refresh the results at a later time.

In some implementations, the computer system 110 can determine the interpretations that are involved in the code or instructions 173 and/or the data processing instructions 174, in addition to or instead of relying on an AI/ML model 132 to generate the interpretations. For example, the computer system 110 can analyze the code or instructions 173 and/or the data processing instructions 174 to identify the logical objects referenced, such as a region identifier attribute and a profit metric. The computer system 110 can use a semantic graph, pattern analysis, or other functionality to identify how these logical objects correspond to terms or phrases in the prompt 170. For example, the computer system 110 can determine that the region identifier attribute corresponds to the term “regions” in the prompt 170 and that the profit metric corresponds to the term “profit” in the prompt. The computer system 110 can generate additional interpretation content, such as a list of logical objects from the data set 122a involved in answering the user prompt 170. The computer system 110 can provide the identified logical objects to the user, along with additional information about them, such as the equations or expressions used to calculate metrics (e.g., profit calculated as the value of a revenue object minus a costs object).

In stage (K), the computer system 110 generates response data 182 and provides the response data 182 over the network 102 to the user device 106 as the response of the chatbot. For example, the response data 182 can include the text of the chatbot response 180 and visualization data for a data visualization 198. The response data 182 can also include information that describes the interpretations used, such as (1) (the interpretation content 192 providing a concise natural language description of the data processing performed or the type of results 176 relied on and/or (2) interpretation content that indicates a list of data objects from a data set used to generate the results 176, potentially with a description or definition of calculations used to generate those data objects.

In addition, the response data 182 can provide an alternative interpretation 196, such as a question that asks the user if a different interpretation should be used. This can show the user the one or more of the most likely alternative interpretations for one or more concepts in the user prompt 170.

When generating the response data 182, the computer system 110 can analyze the various potential interpretations found and their corresponding scores 166 to determine whether to present any alternative interpretations to the user. For example, when the computer system 110 determines that appropriate criteria are satisfied, the chatbot response can indicate the second-most-likely interpretation (e.g., the predicted next-best alternative interpretation) to show the user what other option was possible but not used. The alternative interpretation can be presented in the form of a question 196 to the user that may facilitate further conversation with the chatbot. The question 196 can be provided as a suggested query or other interactive element that the user can select to cause the prompt 170 to be processed again with the alternative interpretation. As a result, because the computer system 110 recognizes the availability of an alternative interpretation (e.g., an alternative mapping of data object(s) from a data set to terms or concepts in the user's question), and provides a user interface control to switch to the alternative interpretation (e.g., to re-run the query or analysis with the alternative mapping), the user 105 can quickly and easily correct an interpretation that is not what the user intended and receive an updated chatbot response.

The computer system 110 can then evaluate those similarity scores to determine whether an alternative interpretation should be provided. For example, the computer system 110 can set a threshold or multiple thresholds such that if the alternative interpretation's score 166 indicates that it is within a threshold level of the score 166 for the primary interpretation, then the alternative interpretation should be indicated and made available through the chatbot response. In the example, the term “profit” is interpreted as a metric “Gross Profit,” but the computer system 110 determines that the next-best interpretation, the metric “Net Profit,” also has a sufficiently high score 166 for relevance or semantic similarity to the term “profit” that an alternative interpretation should be provided. As a result, the computer system 110 provides data to cause a question 196 suggested prompt with the interpretation “Net Profit” indicated to be provided. This can be done by providing the name of the metric, “Net Profit,” to populate a predetermined form or phrase, e.g., “Did you mean [ ]?,” where the name of the metric or attribute replaces the brackets.

In stage (L), the user device 106 receives the response data 182 and displays the response data 182 in the user interface 162. For example, the user device 106 presents the chatbot response 180 and the visualization 198 of the results 176. The user device 106 also presents the interpretation content 192 that summarizes or describes the data processing criteria used.

In addition, the user interface 162 can also provide the question 196, as a suggestion or as a message indicating the alternative interpretation. This is shown in the example as the question to the user, “Did you mean Net Profit?,” with net profit representing an alternative metric to use instead of the gross profit metric used in the chatbot response 180 and indicated in the interpretation statement 192. If the user had intended to use net profit instead of gross profit, the user can simply respond “yes” in a chatbot text field, or click or tap the “Net Profit” phrase in the question 196 (or the question 196 itself) to cause the chatbot to generate a new response that uses net profit instead of gross profit.

Although not illustrated in FIG. 1, the user device 106 can also present the interpretation content that indicates the logical objects derived from the data set 122a, along with potentially equations, expressions, or operations that show how one or more of the logical objects was calculated, especially for metrics that do not exist natively in the relevant source data set 122a used.

Because the user interface 162 shows the interpretation content 192 and question 196, the user 105 can quickly see if the chatbot is providing a response that correctly interprets the user's prompt 170. The content 192, 196 provides the user 105 insight and access to the internal data processing criteria used in generating the chatbot's response, allowing the user to quickly see if the interpretation varies from what the user 105 intended. This includes potentially showing the actual algorithm or equation that the AI/ML model 132 specified, through SQL or other code or instructions 173, to be used for calculating results. In addition, the content 192, 196 can reference the logical objects (e.g., metrics, attributes, etc.) of the source data set 122a, which shows the specific types of data the chatbot relied on and can give the user 105 confidence about the quality of the response. Similarly, the same content 192, 196 can reveal errors, such as in the case that the data sets used do not provide the needed data and the user's prompt 170 is mapped to incorrect logical objects that do not align with the intended meaning of the prompt 170.

The computer system 110 can use information derived from the data processing instructions 174 to generate visualizations, such as the visualization 198. Interpretations can be presented for visualizations, in the same manner as for chatbot answers. Similarly, interpretation content can be determined from a visualization specification that specifies characteristics of a visualization and/or data processing criteria for obtaining the data to be presented in a visualization.

In some implementations, the computer system 110 examines the data processing instructions 174 (and/or the code or instructions 173) to determine characteristics of a visualization to be created. For example, the computer system 110 can examine the data processing instructions 174 to identify data objects, relationships, and other aspects that can be mapped to features of a visualization. The computer system 110 can specify the characteristics of the visualization in a visualization specification 175, which can indicate any of various features to be shown (e.g., data objects to be retrieved or calculated, visualization type, which data series to be illustrated, independent or dependent variables, data ranges, labels for visualization components, and so on).

In some implementations, the visualization specification 175 includes sufficient information for a data processing system, such as the database system 120, to retrieve and calculate all of the data needed to create a visualization or to refresh the visualization with updated information from the data set 122a. In some cases this includes indicating when new logical objects or new quantities need to be defined. For example, if a visualization would use a new column of data that is not natively stored in the data set 122a but is calculated based on columns of data in the data set 122a, the visualization specification 175 can define this column and specify the operations or expressions used to calculated it. For example, if a visualization involves a “profit” metric not stored in the data set 122a, the visualization specification 175 can define the “profit” value to be a “sales” value minus a “cost” value, where the “sales” and “cost” are values (e.g., attributes or metrics) that are part of the data set 122a. As a result, using the visualization specification 175, the database system 120 would be able to identify the types of data that need to be retrieved and/or calculated and generate those values for the visualization. In some cases, the system can also save a metric definition based on the relationships or operations involved in creating a table or specified in a visualization specification. Saved metric definitions can be created for temporary tables or temporary visualizations used for intermediate processing and/or for a final table or final visualization that represents the answer to the user's prompt. The saved metric definitions can be made available in other interfaces, e.g., for filtering data, for creating or editing a dashboard, and so on. In some implementations, the saved metric definitions can be saved in a data model 149 so they can be used in the same manner other metrics in the data model 149 are used. Data processing stages that involve selecting data (e.g., from a range of time, from a geographic area, for certain identifier ranges, etc.) can similarly be saved as filter definitions that can be reused, including by providing them in user interfaces for users to select and apply later.

For example, the computer system 110 can examine a SQL statement to identify data that is retrieved or calculated. The significance of the different types of data referenced can be inferred from the clauses, commands, or operators used in the SQL statement. Based on the information extracted, and the data model 149 describing the semantic meanings, data types, and/or relationships of these data objects in the data set 122a, the computer system 110 can select a visualization type, e.g., line graph, bar chart, pie chart, heat map, geographical map, etc. The selection can be based on any of multiple factors, including the number of attributes and metrics referred to (e.g., where some visualization types are better suited for larger numbers of data objects), the number of data series (e.g., line charts can show multiple data series, while a pie chart is better suited for a single group of values), relationships of the data objects (e.g., with line charts and bar charts showing relationships with respect to time better than geographical maps, which show relationships with respect to locations), the semantic meanings of the data objects (e.g., a geographical map being more likely when a city, state, country, or other geographical independent variable is present), and so on.

The visualization specification 175 can also specify other properties that may be selected based on factors or sources other than the content of the data processing instructions 174 or code or instructions 173. For example, the computer system 110 can store templates that specify visual properties for layout, formatting, font, size, color, and so on. The style template or visual style used can be selected based on user preferences, a selection for the company or other organization, a style of the current document or project in the user interface 162, a default style, and so on. These visual properties can be included in the visualization specification 175 or the visualization specification 175 can include an identifier or reference (e.g., URL) to a source of style information (e.g., a style template document, a cascading style sheet, etc.).

In some implementations, the computer system 110 can determine the type of user that is present, and vary the level of interpretation information accordingly. In some implementations, the computer system 110 determines a user type classification or determines the type of interpretation to provide based on access privileges of the user for the current document being viewed, for the current data set being accessed or manipulated, or for the AI/ML chatbot being accessed. For example, the computer system 110 can provide average users (e.g., business users of a database system) a natural language statement (e.g., the interpretation content 192) describing the interpretation the query by the AI/ML model along with the response from the AI/ML model. The computer system 110 can provide other users with higher access privileges (e.g., power users, administrators, data architects, etc.) the natural language text statement describing the interpretation as well as the interpretation content, e.g., an identification of logical data objects (e.g., attributes, metrics, facts, etc. that represent or are derived from data sets, tables, columns, rows, fields, etc.) and other objects (e.g., applications, objects, documents, etc.) used by or referenced by the AI/ML model in determining the response to the user prompt. These users can also be provided a user interface control (e.g., a button, icon, etc.) that users can access to obtain a copy of a SQL statement generated by the AI/ML model 132 (e.g., the code or instructions 173) or the data processing instructions 174.

For average users or business users, the system can use a standard template for providing interpretations of user prompts. For example, the system can begin with “Interpreted as:” followed by a concise, rephrased version of the user's question that explicitly states the filter criteria used for analysis, such as the time frame, and any sorting applied. If the question was asked with a specific visualization in context (e.g., as part of the user prompt, current task or document view, or conversation history), the system can reference that visualization specifically by name, by adding “based on [visualization name]” to the text of the interpretation statement. In some implementations, the interpretation statement can be a natural language text narrative describing or summarizing the interpretation. This interpretation statement can be generated by asking one or more AI/ML models 132 to generate a text description (e.g., a summary, overview, explanation, etc.) of the function of the generated code or instructions or of the interpretations made in the generated code or instructions. Information from a data model or data schema also enables the AI/ML models 132 to accurately describe the interpretations with natural language terms that the user can understand and recognize from the data set.

As an example, a user prompt may be, “Can you show me the best-selling products?” To provide the AI/ML interpretation, the system can provide an along with the chatbot response such as, “Interpreted as: Displaying top 10 products by total sales volume for the current year.”

As another example, a user prompt may be, “Who are the top five performing employees in the last two years?” To provide the AI/ML interpretation, the system can provide an along with the chatbot response such as, “Interpreted as: Top five employees ranked by performance score for the years 2021 and 2022, sorted in descending order.”

In some implementations, the rephrased version of the user's question and/or the data processing criteria (e.g., for selection, aggregation, sorting, filtering, etc.) can reference data elements from one or more relevant data sets, such as a data set being represented in a current document the user is viewing or a data set associated with the chatbot. For example, the user prompt can be processed by the AI/ML model with a data model or data schema for the relevant data set(s) in the context of the AI/ML model, so that the chatbot responses, including any SQL generated or natural language text generated, can refer to the actual logical data elements available from that data set.

For a more detailed description of the interpretations used, the system can generate and provide additional items. As an example, a source of information that sets or limits a scope of data being considered can be indicated, such as identifying a particular visualization in context, a document page or section filter setting, or an “in-canvas” selection indicating one or more data sets and/or subsets of the data sets being examined. The interpretation information can show analysis steps applied, such as forecast analysis, trend analysis, key driver analysis, and so on. The interpretation information can also indicate the logical objects used, such as attributes, metrics, derived attributes, derived metrics, filter expressions, sorting expressions, and so on. The content can also include the formula expression for derived metrics, e.g., types of data that are not natively available from a data set but are calculated from the data in the data set.

When a multi-pass SQL statement is involved, the system can provide a detailed breakdown of the steps involved in creating the visualization. This will include the specific attributes, metrics, derived elements, and other components used in each step of the process, along with the intermediate results that lead to the final answer.

In some implementations, an interpretation region 194 portion of the interface 162, which includes interpretation content, is collapsed and hidden from view on initial presentation, until the user 105 selects to view the interpretation region 194 by clicking a particular interpretation icon, ensuring a clean and uncluttered interface and conserving limited screen area for the chatbot answer the user 105 requested.

A “copy to query” navigation icon can be included adjacent to the interpretation text, allowing users to easily paste the interpreted question back into the chat for further queries or adjustments.

The feature can be configured to provide the ‘Interpreted as’ explanation alongside every successful answer, e.g., answer where a substantive response to the user query 170 is provided. In cases where the chatbot delivers an error or fails to provide an answer, the option to view the interpretation may be hidden and inaccessible. When a user asks a question while selecting a specific visualization in context, the interpretation can clarify that the provided answer is based on the data from that particular visualization. If a user utilizes an in-canvas selector control to select particular objects or data, and the computer system 110 or the chatbot takes this into account when responding, the interpretation can acknowledge the selector's influence to offer a clearer context for understanding and problem-solving.

In general, generating and providing the interpretation information offers a transparency that assists users who value understanding AI processes. The system enhances transparency and trust by demystifying the AI's processing. In an industry where black-box solutions are common, offering transparency can significantly differentiate the system from others, benefitting users who prioritize understanding how their data is being analyzed and interpreted. The interpretation information not only provides an answer but also educates the user on the logical steps taken to reach that conclusion. This educational aspect can enhance the user experience, and helping users learn and develop their analytical skills. By revealing the steps taken to interpret and answer questions, users gain a clearer understanding of how to structure queries effectively and interpret results, speeding up the learning curve and enhancing overall user experience. If a user receives an unexpected answer to their query and gives a thumbs down, the interpretation information allows both the user and the system administrators to see the exact steps the AI took to interpret and answer the question. This transparency helps in quickly identifying where misunderstandings or inaccuracies occurred, enabling swift corrections and improvements to the AI's processing logic.

The interpretation feature also enhances enhanced transparency for sensitive or critical data analysis. For example, in industries like healthcare or finance where decisions based on data can have significant consequences, users need to fully understand how conclusions are drawn. The system provides the necessary transparency and detailed explanation, ensuring that users are fully informed about the basis of the AI's conclusions, thus supporting responsible and informed decision-making. In addition, the interpretation information facilitates continual improvement and overall learning of the system in a feedback loop. Over time, users might find certain patterns of queries consistently yield less satisfactory results. Generating and providing interpretation information allows for a direct feedback loop, where users can flag issues with specific interpretations or execution steps. Analysts and developers can then use this targeted feedback to refine algorithms, improve natural language processing capabilities, and enhance the overall accuracy and effectiveness of the AI system.

For business users, the system can present AI's understanding of user questions affirmatively and clearly. The output can include references to specific visualizations if queries are made in that context, and can enable users to copy and paste interpretations into the chat for consistent results. For power users, the system can identify detailed visualization components and SQL generated by the LLM. Interfaces can include a discrete icon for copying LLM-generated SQL, aiding in validation and troubleshooting. For multi-pass SQL, show a step-by-step breakdown of visualization creation can be provided.

The chatbot can ask follow-up questions or give recommendations to clarify user intent. With these interactions, the aim is to address ambiguities in user queries, by introducing conversational clarification. Often, user queries like “Show me which month had the highest sales in the last 3 years” can be interpreted in multiple ways. This ambiguity can lead to half-answers or inaccuracies. The goal of this feature is to enhance user interaction by allowing the chatbot to seek clarification through follow-up questions. This can enable more precise responses and a more engaging user experience. In addition, the system can balance this functionality to avoid excessive clarification requests, which could negatively impact the user experience.

When users ask follow up questions in the chat conversation, the chatbot can be configured to maintain a natural dialogue by retaining context of the conversation. For example, previous prompts, responses, and the interpretations used (e.g., the mappings of data objects, or even the data table results generated for responses) can be included in the context provided to the LLM.

The system can streamline complex data queries, with a straightforward approach to handling complex data questions, offering a clear advantage in user-friendliness and efficiency. The user experience can be enhances by simplifying the process of querying complex data sets, making advanced data analysis more accessible to a broad audience, and not just data experts.

The system can be configured to convert multi-pass SQL statements to visualizations, with the ability to parse and effectively answer user questions that trigger multi-pass SQL statements from the LLM. The system can support data blending and multiple dataset support. For example, the chatbot can effectively answer compound questions using multi-pass SQL approach even in dashboards or chatbots that are associated with more than a single dataset. Examples of compound questions that are likely to generate multi-pass SQL statements include:

“What are the average revenues for products sold by the top 10 employees with the
highest revenue?”
“Across departments, which have seen a salary increase in the last year, what are the
common job roles?”
“Compare the annual revenue growth in New York to that of Milwaukee over the last
three years.”
“Identify customers who purchased more than five times last year but have not made any
purchases this year, and list their most frequently bought items.”
“Which employees exceeded their sales targets in all four quarters last year and what was
their average customer satisfaction score?”

As shown in FIG. 1, the computer system 110 can provide a conversational experience to indicate and provide easy access to different interpretations for user prompts. The chatbot can intelligently determine when to seek user clarification by recognizing potential ambiguities in queries and responding with a set of options or a question to ascertain the user's precise intent. As an example, a user may ask, “Show me which month had the highest sales in the last 3 years.” Given the ambiguity of this query, the computer system 110 can recognize the potential for multiple interpretations, e.g., the user may be asking for the single month with the highest sales out of all 36 months, or may be seeking to identify the month of the year that, when summed across the three years, had the highest sales. To clarify, the chatbot can provide the answer with the interpretation predicted to be most likely, as well as by engaging the user with a follow-up question, offering a couple of options or posing an open-ended question. For instance, the chatbot can respond, “April consistently recorded the highest sales over the last 3 years. Here is a visualization showing the figures . . . . If you want to know the single highest sales month within the last 36 months, please specify.” As another example, the question to the user can be phrased to allow a simple yes or no response to accept the alternative interpretation, such as “would you like to know the single highest sales month within the last 36 months?” This way, the user can respond with a simple “yes” to initiate generation of a new answer based on the alternative interpretation.

As another example, one or more suggested prompts can be provided that are based on an alternative interpretation. The suggested prompts can involve or be based on a different mapping of a data object in a data set to a portion of the prompt, to be used for selection, filter, aggregation, or other operations in a SQL statement. For example, after a different data object is found, a label or description of that data element can be used to replace the term it is interpreted to correspond to, to result in a natural language prompt that would result in the new mapping.

The chatbot can be designed to initiate this type of conversational clarification only when there is significant ambiguity that could lead to incorrect or incomplete answers, ensuring that this feature enhances the user experience without causing undue interruptions or delays in query processing. For example, the computer system can generate scores that indicate the predicted relevance or strength of connection between the user query and the various interpretations. In this process, the computer system 110 can use comparisons of vector representations, to assign scores based on distances in the vector space. As another example, the computer system 110 can use a semantic graph and assign scores based on the strength of connection among items in this semantic graph. As another example, the computer system 110 can ask one of the AI/ML models 132 to assign scores or likelihoods four different interpretations. As another example, the computer system can use a combination of these techniques, such as by asking an AI/ML model 132 to identify and state possible interpretations, and then using the vector database and slash or semantic graph to calculate scores for each of those interpretations that are identified by the AI/ML model 132. With any or all of these techniques, the computer system 110 can determine likelihood scores, relevant scores, or confidence scores indicating the strength or suitability of each interpretation for the current user question.

In making assessments of potential interpretations and in assigning scores, the computer system 110 takes into account the context of the user's request. This includes previous user questions and chatbot responses in the conversation, and potentially previous conversations of the user with the chatbot in previous chat sessions. In addition, the context includes the data set or data sets that the chatbot is configured to answer about. In addition, the chatbot may use context of a particular data item, such as a particular data table, visualization, data range, document page, document, or other content that is active, selected, or displayed in a user interface alongside or concurrently with the chatbot interface being used.

Using the scores for the various interpretations, the computer system 110 applies rules or other criteria to determine whether conditions are satisfied to surface one or more alternative interpretations to the user. For example, the computer system 110 can be configured to show an alternative interpretation only when the score is for the most likely interpretation and second most likely interpretation are within a threshold distance of each other. Yes the second best interpretation has a far lower score then the predicted best interpretation, then the computer system 110 will not ask the user about the alternative interpretation option. On the other hand, if the top two interpretations have similar scores, e.g., the score for the first interpretation does not exceed the score of the second interpretation by at least a minimum amount, then the computer system 110 can provide the alternative interpretation in the chatbot response, such as in a question to the user.

The computer system 110 can enable chatbots to generate and provide follow-up questions for an enhanced conversational experience, even if the questions do not specify a different interpretation from the one used in generating the current response. For example, a user may ask, “In which quarter did we hire the most employees?” The computer system 110 orchestrates the chatbot response, which includes data for the single quarter across all years with the highest number of hires (e.g., if there are 4 years of data, the chatbot provides the quarter that recorded highest hiring among the last 16 quarters). The chatbot can then ask, “Are you interested in the quarter of the year across all available years with highest hires? Please specify.” In this example, the chatbot provides the interpretation the chatbot actually used in the follow-up statement to the user, rather than specifying an alternative interpretation. This follow-up statement or question can emphasize to the user the nature of the interpretation used, even if strong alternatives were not found, or can be another way to formulate interpretation content and provide it to the user.

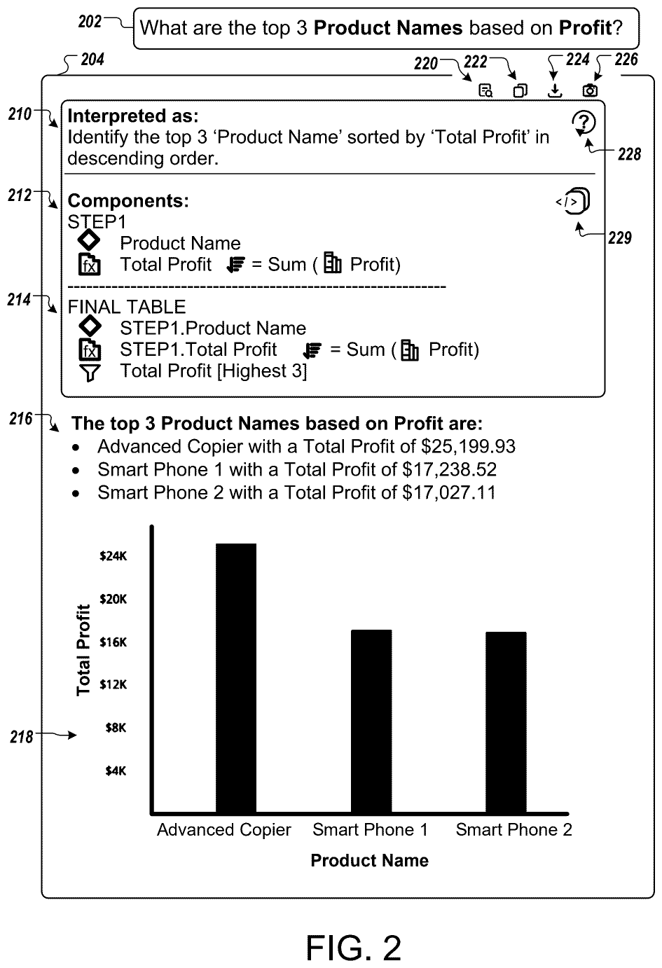

FIG. 2 shows another example of a chat interface, where a user prompt 202 leads to a chatbot response and interpretation information that describes how the user prompt 202 was interpreted and how data was processed to arrive at the response.

In the example, the user prompt 202 is the question, “What are the top three product names based on profit?” In the interface, the system has identified the terms “product names” and “profit” in the prompt 202 as representing data objects that are either included in, or can be derived from, one or more data sets, e.g., one or more data sets relevant to a current conversation, current task, current document, or the chatbot itself. To indicate that these terms have been mapped to data objects, the identified terms with identified data objects can be visually distinguished in the user interface, through differences such as color, size, highlighting, underlining, and so on. The computer system 110 can identify these terms as corresponding to particular data objects in one of various ways, such as through the interpretation content discussed further below. As another example, the computer system 110 can identify relevant data objects for terms based on a semantic graph or other data.

The example shows a response 204, which shows the response of the chatbot to the prompt 202 as well as interpretation information. The interpretation information includes an interpretation summary 210, which is a natural language statement that provides a concise description of the data processing (e.g., data retrieval and/or calculation) performed to answer the user's prompt 202. The interpretation summary can represent an interpretation or restatement of the user prompt 202. In particular, the interpretation statement 210 includes the criteria derived from the prompt 202, such as criteria interpreted as being specified by the prompt 202 or needed to answer the prompt 202. This can include criteria for retrieving and processing data (e.g., aggregating, sorting, filtering, etc.).

In addition, or as an alternative, the interpretation summary 210 can represent a summary or restatement of the data processing operations performed to retrieve and generate data presented in the chatbot's response (e.g., response text 216 and visualization 216). For example, the interpretation summary 210 can include or be based on natural language text generated by the AI/ML model 132. The interpretation summary 210 can be text generated by the AI/ML model 132 in response to a request for the AI/ML model 132 to summarize or state in natural language the operations or criteria specified in a set of code or instructions.

For example, the computer system 110 can provide a set of code or instructions used by the database system 120 to generate the data or the results used to provide the chatbot response text 216 and visualization 218. The AI/ML model 132 may be used to generate code or instructions based on the user prompt 202, and then the code or instructions (or a modified version of them) can be provided back to the AI/ML model 132 with a request to summarize the operations called for. For example, the AI/ML model 132 can be used to translate from a set of data processing instructions, such as a SQL statement, to a natural language summary. Depending on the implementation, other techniques can be used. For example, the interpretation summary 210 can be generated by asking the AI/ML model 132 to summarize or restate the user prompt 202 itself.

The response 204 includes additional areas that further identify the logical data objects accessed or calculated when generating the database results used to answer the prompt 202. For example, the data retrieval and data processing for answering the user prompt 202 involves two steps, and so a description of each step is shown separately in the interpretation panel. A first section 212 shows components of a first step or first stage of processing. The section 212 identifies various data objects as components of the data set used in generating the chatbot response. For example, the first step is identified as involving a table STEP1 that was generated as intermediate data before reaching the final results. The table STEP1 has an attribute labeled “Product name” and a metric named “total profit” which are both derived from the source data set. The section 212 also defines the metric “total profit” with an expression that specifies the operation used to generate values of total profit. For example, the section 212 indicates that total profit is the result of summing a set of values of a “profit” quantity, which can represent a fact or data item in the source data set.

Region 214 shows the second step or stage of processing which results in a table labeled “FINAL TABLE.”. This table is shown having information from step one that is further processed or manipulated. For example, there is an attribute STEP1.Product Name and a metric named STEP1.Total Profit. These data objects are taken from the STEP1 table referred to in region 212. In addition, the region 214 indicates that the data is filtered to show the three products names with the highest profit. In the regions 212 and 214, icons designate whether the various data objects are metrics, attributes, facts, filter criteria, or other types of data objects.

The information in the regions 212 and 214 can be taken from the data processing instructions used to generate the results used to generate the chatbot output 216 and visualization 218. As with the interpretation summary 210, the set of data objects and relationships shown in the regions 212 and 214 can indicate the set of data objects and data processing operations on which the chatbot response below is based, as determined based on the code or instructions from an LLM or a modified version of the code or instructions from the LLM. In some implementations, if the AI/ML model 132 is used to generate a SQL statement based on the user prompt 202, if the system modifies that SQL statement, the interpretations shown in the regions 212 and 214 can be based on the modified version that was actually processed by the database system 120.

The content of the regions 212 and 214, and in particular the identification of data objects used and equations or data processing operations performed, can be generated by the computer system 110 based on the final set of data processing instructions used to retrieve data by the database system 120. In other words, after a final modified or enhanced SQL statement is ready, the computer system 110 can identify the logical data objects and their definitions from that enhanced SQL statement. Because these data elements are part of the data schema or data model for the data set, the computer system 110 can readily extract the references to these data items and also any equations or other criteria defined therein. The computer system 110 can store a set of rules or patterns or keywords that assist the computer system 110 to map phrases or patterns of syntax in SQL statements that correspond to different operators, functions, or other types of content.

The response 204 includes the chatbot response text 216 below the interpretation content. This example also shows a visualization 218 that is generated based on the results retrieved from the data set. The chatbot response text 216 can be generated by the chatbot, based on the user prompt 202 and also the results the database system 120 generated from the source data set. In some implementations, the visualization 218 can be generated by the computer system 110 based on the data processing instructions or SQL statement used, but the visualization data for the visualization 218 can be generated in a deterministic manner without using an AI/ML model. For example, as discussed above for FIG. 1, a visualization specification can specify properties of a visualization, including the data to retrieve and processing to obtain the data to be represented in the visualization 218. From that information, the computer system 110 can generate the visualization data for the visualization 218.

The response 204 can include various user interface controls that enable the user to initiate various functions. For example, a control 220 is selectable by the user to show or hide the interpretation content, e.g., the panel that includes the interpretation summary 210 and the content in regions 212, 214.

The interface can include a control 222 to copy some are all of the content in the response 204. For example, the control 222 can be provided to copy interpretation content (such as the interpretation statement 210) and/or response content (e.g., chatbot output 216 and visualization 218) to a clipboard of the user device for use or export in other applications.

The interface can include a control 229 configured to cause code or instructions used generate data for the response to be copied to a clipboard or presented for view. For example, when a user clicks or taps the control 229, the interface can cause the SQL statement that the interpretation content in 210, 212, 214 is describing, e.g., the SQL statement generated by an AI/ML model 132 in response to the prompt 202, to be copied to a clipboard. As an alternative, clicking the control 229 may cause the SQL statement to be presented in a pop-up window or opened in an editor for the user to view. In this manner, the interface provides the user a way to export or obtain the SQL statement used in responding to the prompt 202, e.g., the SQL statement generated by an LLM or used to retrieve the results used to generate the response 216 and response visualization 218.

Another control 224 allows a user to download content of the response 204. The control 226 allows the user to take a snapshot as a way of capturing the content of the response 204, such as by creating or saving a screenshot image of some or all of the response 204. In addition, or as an alternative, the control 226 can create a type of snapshot in the chatbot to save the response 204 and associated context, so the current portion of the conversation is saved and remains available for the user in future sessions, similar to bookmarking or tagging this response 204 for quick retrieval in the future.

The interface includes an additional control 228 that can be selectable by a user to copy the natural language text interpretation into the text entry field of the chat interface. For example, the control 228, when clicked or tapped by a user, can insert the interpretation summary 210 into the text entry field where the user enters prompts to the chatbot. This quickly places the data processing criteria in the text entry field, where the user can make adjustments and corrections to refine the request to the chatbot. This allows users to iteratively refine their prompts using a clear and unambiguous set of criteria.

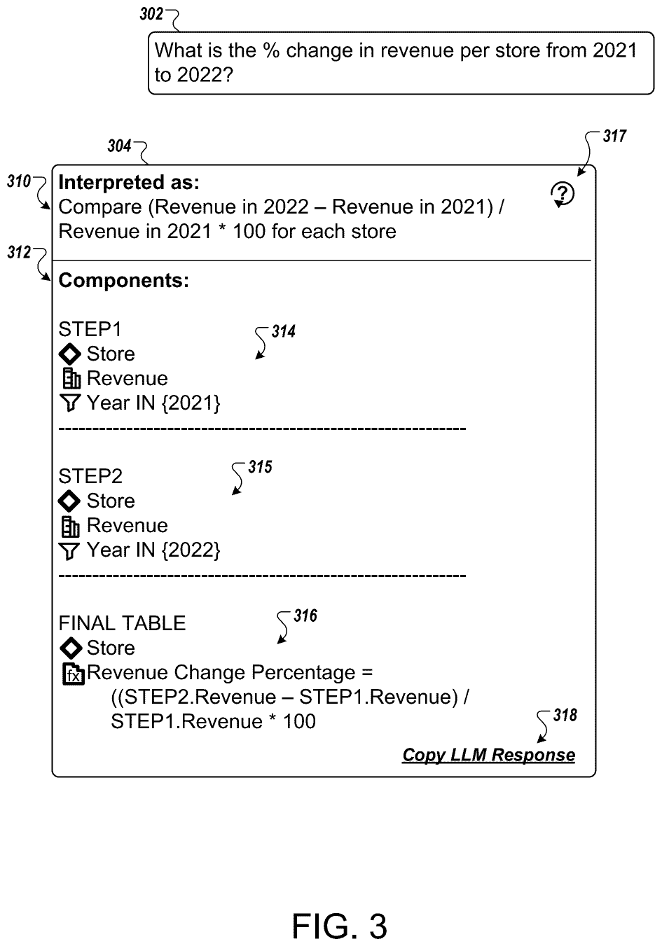

FIG. 3 shows another example of a chat user interface. The user submits a user prompt 302, “What is the percentage change in revenue per store from 2021 to 2022?” In the example, only the interpretation content is shown, and the main chatbot response is omitted.

The interpretation content 304 includes an interpretation summary 310, which illustrates in text. Logical data objects used and criteria applied, and how they relate to calculate the results that answer the user prompt 302.

The interpretation content 304 also includes a more detailed list of components 312, to indicate the attributes, metrics, filter criteria, and other items. As with other interpretations, a list of data objects used can be extracted from code or instructions generated by the AI/ML model 132 or an enhanced or updated version of the code or instructions. For example, a modified SQL statement used to generate the results for responding to the user prompt 302 can be the source analyzed to determine the list of components 312.

In this example, the SQL statement includes multiple steps, including the generation of two intermediate tables or data sets, and a final table to obtain the final result. The first step involves creating a table STEP1, which includes a “Store” attribute, a “Revenue” fact or metric, and a filter to limit data to the year 2021. The second step involves generating second intermediate table named STEP2, which includes the “Store” attribute and the “Revenue” fact or metric, filtered to the year 2022. The final step 316 involves creating a “FINAL TABLE,” which again involves the “Store” attribute, and also has a metric named “Revenue Change Percentage.” The definition of this metric is specified as an equation or expression that references data from the STEP1 table and the STEP2 table. For example, the “Revenue Change Percentage” metric is defined by the calculation of “Revenue” from STEP2 minus the value of “Revenue” from STEP2, with that quantity being divided by the revenue from STEP1 and multiplied by 100. The result will provide the change of revenue per store as requested in the user prompt 302.

The interface includes a user interface control 317 that, when interacted with by a user, copies the interpretation summary 310 into the chatbot input field so the user can ask again the same question, or so the user can add context or edit the question. For example, the user may determine that the AI/ML model 132 used a different data object or a different filter setting than the user intended. The user can interact with the control 317 to insert the interpretation summary 310 into the chatbot interface as a new prompt, and the user can correct the error or specify additional context that would allow the AI/ML model 132 to improve the result in the next response. In some implementations, a control can be provided to copy the interpretation summary 310 to a clipboard to the clipboard for use in other interfaces or applications.

The user interface also includes a user interface control 318 that, when interacted with by a user, copies the SQL statement or other code or instructions used. For example, when a user clicks the control 318, code or instructions generated by the AI/ML model 132, or the enhanced or updated version processed by the database system 120, is copied to the clipboard.

The interpretations help users understand how AI processes and understands queries, to provide clarity and confidence in every result. This allows on-the-fly refinement, so users can refine questions in real-time, ensuring responses are optimized for the most relevant insights. It also allows advanced testing and troubleshooting, so power users can see detailed execution pathways, including specific data objects or data set components used, enabling advanced diagnostic capabilities.

For power users, when a multi-pass SQL statement is involved, the interpretation content can provide a detailed breakdown of the steps involved in creating the visualization. This can include the specific attributes, metrics, derived elements, and other components used in each step of the process, along with the intermediate results that lead to the final answer.

In some implementations, the interpretation region remains collapsed or hidden until a user chooses to view it by clicking the interpretation icon, ensuring a clean and uncluttered interface. A “copy to query” navigation icon can be included adjacent to the interpretation text, allowing users to easily paste the interpreted question back into the chat for further queries or adjustments. The interpretation feature can ensure that the ‘Interpreted as’ explanation appears alongside each successful answer. In cases where the chatbot delivers an error or fails to provide an answer, the option to view the interpretation can be hidden and inaccessible.

When a user asks a question while selecting a specific visualization in context, the interpretation can clarify that the provided answer is based on the data from that particular visualization. If a user utilizes an in-canvas selector (e.g., to select a visualization or region of a document) and the chatbot takes this into account when responding, the interpretation can acknowledge the selector's influence to offer a clearer context for understanding and problem-solving. The interpretation content can also include the formula expression for derived metric.

The interpretation content can be saved as part of a snapshot, with an option to copy the interpretation to the chat. The interpretation and execution steps for a specific question can be accessible only during the session in which the question was asked, unless it was saved to snapshots. This means that when a user ends their session with the chatbot and later returns to continue the chat, the interpretation icon won't appear for answers from the previous session.

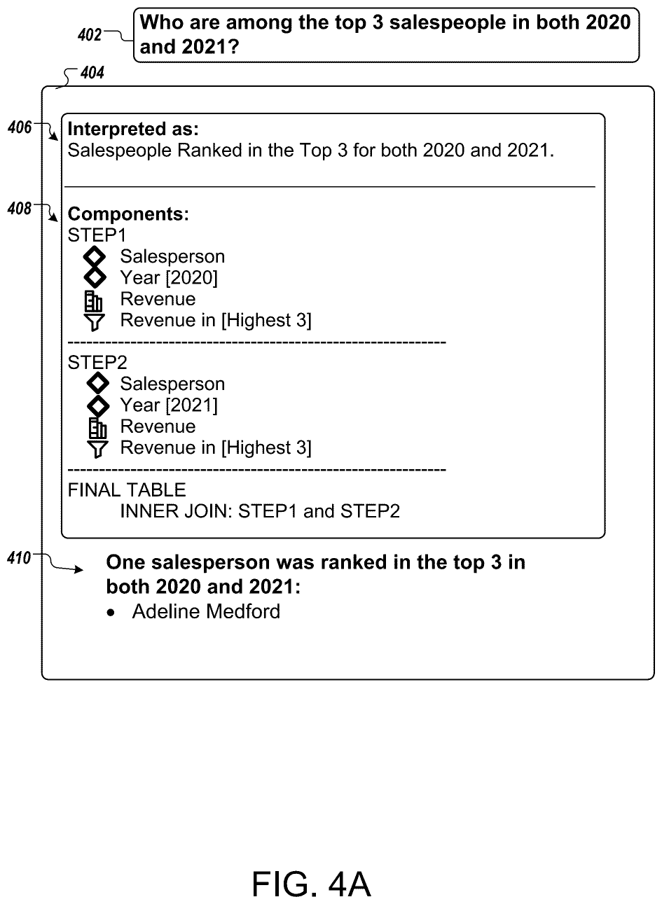

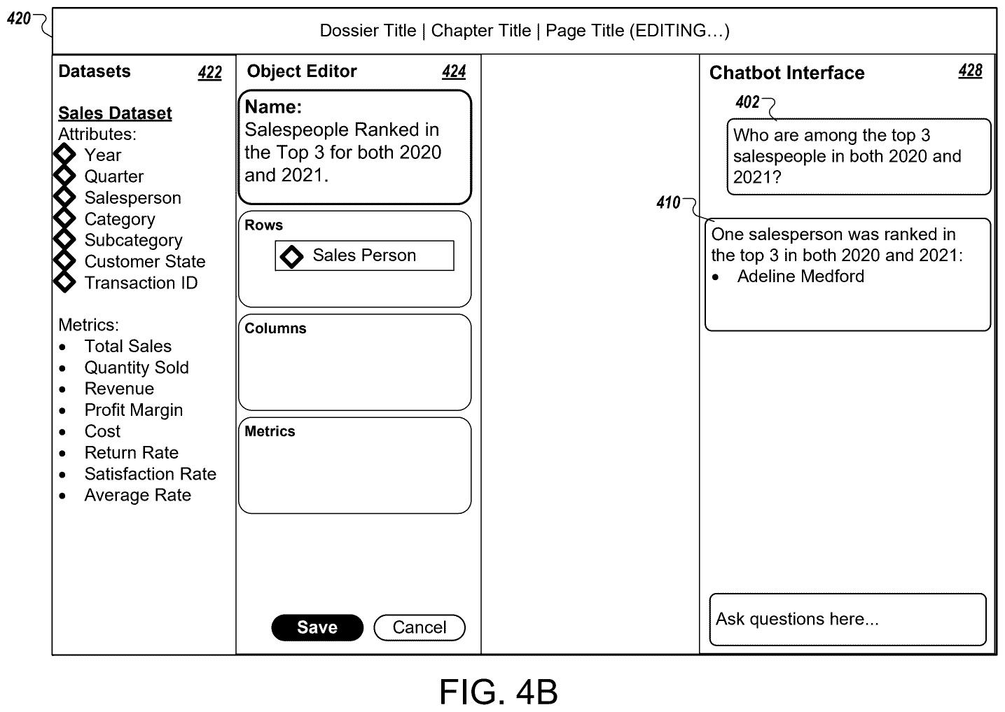

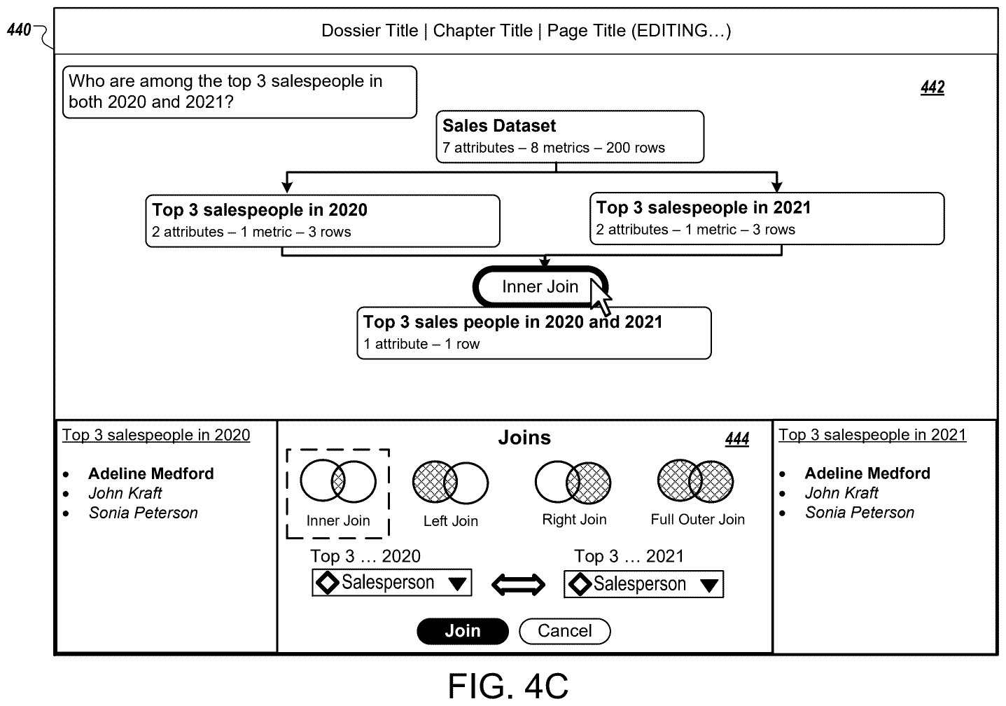

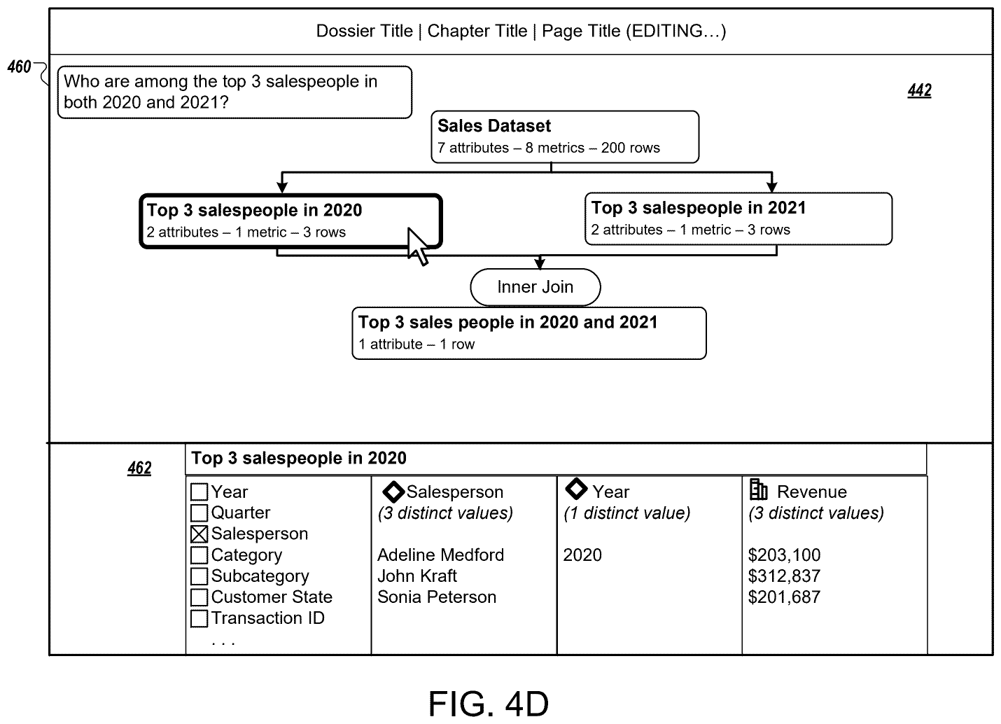

FIGS. 4A-4D show an example of how the system can interpret a user prompt to include multiple data processing steps, and also allow the series of data processing steps to be saved, edited, reused, and published for use in other situations. As a result, the system allows a user to extract the data processing operations generated by an AI/ML model 132 in response to a question to a chatbot, and then edit them in a visual interface for editing instructions directly (e.g., by editing SQL statements or Python code). As a result, the interfaces enable a user to quickly generate a complex data processing pipeline based on the natural language query to chatbot.

FIG. 4A shows a user interface 400 that displays a prompt 402 from a user, which states “who are among the top three salespeople in both 2020 and 2021?” The user interface 400 also shows a chatbot response 404, including a text answer 410 and interpretation content. The interpretation content includes a natural language statement 406 that summarizes the data processing steps used to generate the chatbot answer 410. In addition, the interpretation content includes a component list 408 that shows each of multiple steps used to generate the data used to answer the users prompt 402, as well as the logical objects or data set components used for each step.

In the example, the component list 408 shows that there are three steps, each involving a different table. The main data set is a sales data table, which this chatbot is configured to use in responding to questions. The first step involves generating a first intermediate table labeled “STEP1,” and this table includes a salesperson attribute, a year attribute limited to the year 2020, the revenue attribute, and a filter operation to filter to the highest 3 revenue values. The second step involves generating a second intermediate table labeled “STEP2,” and this table includes a salesperson attribute, a year attribute limited to the year 2021, the revenue attribute, and a filter operation to filter to the highest 3 revenue values. The third step includes a final table, labeled “FINAL TABLE,” created by joining the STEP1 table and the STEP2 table with an inner join.

In the example, the intermediate tables and data objects and operations represented in the interpretation content are identified from the code or instructions (e.g., SQL statement or Python code) generated by an AI/ML model 132. The computer system 110 parses the code or instructions to identify the logical objects used and operations performed. This information can also be used for other purposes as shown in FIGS. 4B-4D. For example, with the data processing operations extracted from the code or instructions, the computer system can define a data processing pipeline or customized data object that can be shared, published, or reused within chapter conversations or outside chatbot conversation interfaces, such as in a wider data processing platform. For example, in some implementations, the computer system 110 can enable the user to define a new metric or new attribute of a data set based on a set of data processing instructions obtained from a chatbot response. Similarly, an object representing the data processing operations or their results can be used to define a visualization or other content.

FIG. 4B shows another user interface 420 in which the prompt 402 and chatbot response 410 are shown in a chatbot interface 428. The user interface 420 includes additional controls that enable the user to view, edit, and save the data processing operations used in responding to the prompt 402. For example, the user interface 420 includes a data set region 422 that lists the active data set or data sets and their components. For example, the sales data set is open and includes attributes such as year, quarter, sales person, category, subcategory, customer state, and transaction ID, as well as metrics total sales, quantity sold, revenue, profit margin, cost, return rate, satisfaction rate, average rate.

The user interface 420 includes an object editor region 424 that includes controls allowing the user to create or edit an object that is based on the prompt 402 and slash or chatbot response 410. The object editor 424 indicates rose that are provided by or represented in the object. In this example, the chatbot response 410 provides a salesperson attribute, e.g., one or more names of salespeople, and so the salesperson attribute is shown as a type of row that is returned. The object editor can include additional controls for a user to add or remove attributes and metrics, or data set elements such as rows, columns, and so on. The object editor region 424 also includes controls that a user can interact with to save the object, change the name of the object, or make other changes.

The information in the object editor 424 can be populated automatically based on a user selecting the chatbot response 410 in the chatbot interface 428, by dragging the chatbot response 410 on to the object editor region 424, or otherwise indicating that an object should be created or saved based on the chatbot response 410. In some implementations, the user can initiate creation or saving of this object through a prompt providing an instruction to do so as a prompt to the chatbot in the chatbot interface.

FIG. 4C shows another example user interface 440 where a user is editing a document, and in the process can view and edit the object created from the chatbot response 410 in FIG. 4B. The user interface 440 includes a visual representation 442 or table view of the data object. For example, the visual representation 442 shows the initial sales data set is used to generate two intermediate tables, “top three salespeople in 2020” and “top three salespeople in 2021,” and then an inner join operation creates the final table “top three salespeople in 2020 and 2021.” This provides the user an opportunity to visualize the types of data created and the relationships between them, as well as to alter the relationships or drill down for additional information.

In the example, the user clicks on the “inner join” element in the visual representation 442, which causes the bottom of the user interface 440 to show information about the joint operation. For example, a join control region 444 shows different types of joins that are available and shows that the inner join is selected. In addition, the joint control region 444 shows which attributes are joined from the intermediate tables and allows the user to use the drop down controls to select different attributes if desired. To the right and left of the join control region 444, preview regions are shown with actual data values from the intermediate tables and the value “Adeline Medford” indicated as the only value that would be shared in the join. After changing the settings as desired, the user can select to perform the join and save any settings that have changed.

FIG. 4D shows another user interface 460 that shows the visual representation 442. This time, the user has clicked the user interface element representing the table for “Top salespeople in 2020” instead of the “inner join” user interface element as in FIG. 4C. In response, the user interface is update to show a different set of information at the bottom, this time relating to the table the user selected. The user is shown in the table control region 462, which includes information about data provided by the object being edited. This includes the salesperson attribute which is checked. Other attributes and metrics are listed so that the user can check them to cause them to be included also in the data that the object represents. The table control region 462 also shows the other data objects used in the table, including the salesperson attribute, the year attribute, and the revenue metric. Examples of values of these attributes and metrics are shown as a preview to the user as well.

Using the interfaces in FIGS. 4A-4D, the user can start with the data processing operations that the AI/ML model created in response to the user prompts 402, and then edit or customize those operations to create new objects that can be used to provide content for documents, visualizations or other items. Similarly, the user can save the object and cause it to be shared, published, or reused by the other users. In some implementations, the user may be shown the SQL statement, Python code, or other instructions corresponding to the new object, so that the user can edit those instructions directly.

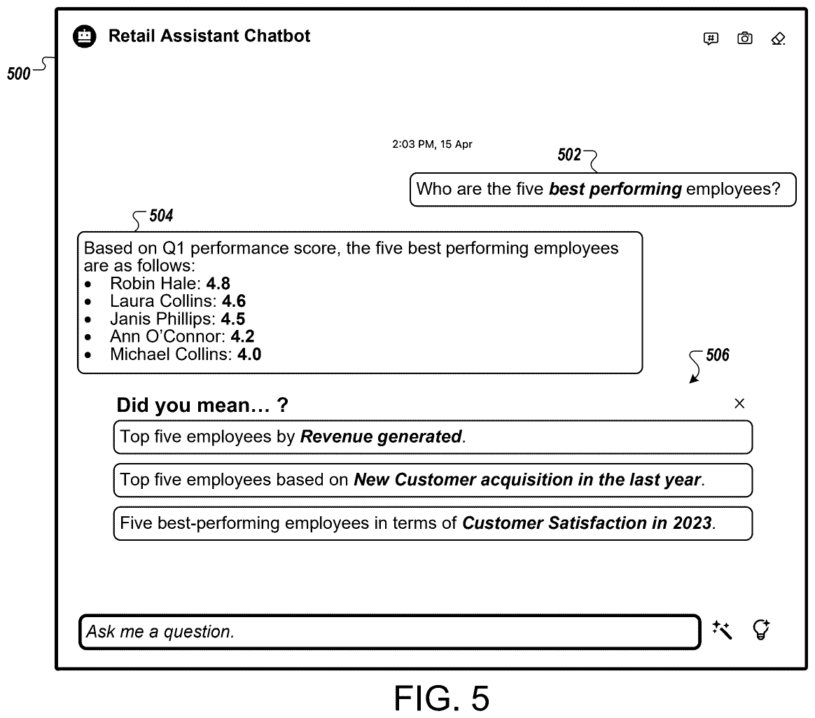

FIG. 5 is a diagram showing another example of a chatbot user interface. In the example, a user interface 500 is shown, with the chatbot interface for a retail assistant chatbot. The user interface 500 shows that a user has submitted a prompt 502, “who are the five best performing employees?” In response, the chatbot has provided a chatbot response 504 that lists the five best performing employees according to a rating scale of values from one to five. As a result, the values used to select and rank these employees our values such as 4.8, 4.6, 4.5, 4.2, and 4.0.

In interpreting the users prompt 502, the AI/ML model 132 (e.g., LLM) needed to interpret prompt 502 to determine which data object from the underlying employee data set should be used to judge which employees are “best performing.” The employee data set may not include a column labeled performance, and so the AI/ML model 132 needs to perform a mapping from the logical objects of the employee data set to the concept of performance. For example, the computer system 110 can request that the AI/ML model 132 provide data processing code or instructions for the prompt 502 and can provide a data model or data schema that identifies and describes the data objects in the employee data set. In some cases, a knowledge base for the organization or for the chatbot is also provided in the request as context, and the knowledge base may include a statement indicating which metrics are used to judge the performance of an employee. Nevertheless, a knowledge base provided and other contexts including earlier conversations still may not provide a conclusive indication of which data object should be used to assess employee performance.

From the available information, the AI/ML model 132 selects an average rating value metric as the metric to use for evaluating employee performance in generating the chatbot response 504. The computer system 110 can determine this based on the AI/ML model 132 using the average rating metric as the criteria to sort and select employees, as specified in a SQL statement provided in response to the request from the computer system 110.

The computer system 110 can identify various interpretations for the concept or phrase “best performing employee.” For example, the instruction to the AI/ML model 132 to generate the code or instructions can also request that the AI/ML model 132 provide alternative interpretations. Similarly, the computer system 110 can itself search for alternative interpretations in chat conversation history, the data model for the employee data set, vector database contents, the semantic graph, or other sources. The computer system 110 can then assign a score to each of the interpretations identified. The computer system 110 can determine whether any of the alternative interpretations (e.g., that differ from the primary interpretation used in the code or instructions from the AI/ML model 132) have at least a minimum threshold level of likelihood or relevance to the prompt 502, and/or if any of the alternative interpretations score within a threshold range of the primary interpretation (e.g., are sufficiently similar that there may be confusion or low confidence in the primary interpretation). If the appropriate predefined criteria are satisfied, the computer system 110 can generate one or more suggested prompts 506 that each use a different alternative interpretation for the concept of “best performing” employees. For example, one suggestion indicates that employee performance can be assessed based on revenue generated, another indicates assessment based on new customer acquisition in the previous year, and a third suggested prompt indicates assessment by customer satisfaction in 2023. These suggested prompts 506 can be interactive so that a user, by clicking a suggested prompt 506, can cause that prompt to be issued to the chatbot, so that the chatbot will provide a new response based on the selected prompt.

As a result, the user can quickly see alternative interpretations and if the users preferred interpretation is among the alternatives represented, the user can know very quickly that the chatbot response 504 was not with the user intended. In addition, the user interface elements for the suggested prompts 506 provide a quick and seamless way to correct the interpretation and obtain a new response with the interpretation the user intended.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

1. A method performed by one or more computers, the method comprising:
receiving, by the one or more computers, a prompt from a user;
obtaining, by the one or more computers, code or instructions generated by one or more artificial intelligence or machine learning (AI/ML) models, wherein the code or instructions specify criteria to retrieve data from a data source to respond to the prompt;
determining, by the one or more computers, that the code or instructions specify multiple stages of data processing;
generating, by the one or more computers, a set of results from the data source based on the generated code or instructions;
obtaining, by the one or more computers, a response to the prompt that the one or more AI/ML models generate using at least a portion of the set of results;
generating, by the one or more computers, an interpretation statement that describes each of the multiple stages of data processing; and
providing, by the one or more computers, output that includes (i) the response to the prompt and (ii) the generated interpretation statement.

2. The method of claim 1, wherein the code or instructions comprise a structured query language (SQL) statement.

3. The method of claim 2, wherein determining that the code or instructions specify multiple stages of data processing comprises determining that the SQL statement includes multiple select commands, includes a join command, or involves creation of multiple tables.

4. The method of claim 1, comprising generating a set of visualization data for each of the multiple stages of data processing, including for an intermediate stage of data processing for which a visualization is not initially displayed when the response to the prompt is displayed;
wherein each set of visualization data defines properties of a visualization for the stage of data processing including a visualization type and data types or data series to be represented in the visualization.

5. The method of claim 1, comprising:
generating a set of visualization data or a table of data for each of the multiple stages of data processing; and
for at least one of the stages of data processing, saving a metric definition or a filter definition based on parameters from the set of visualization data or operations used to generate the table of data.

6. The method of claim 1, wherein the interpretation statement includes, for each of the multiple stages of data processing:
an indication of data objects used in the stage of data processing; and
operations performed on the data objects to generate the output of the stage of data processing.

7. The method of claim 1, wherein the one or more AI/ML models comprise a large language model (LLM).

8. The method of claim 1, wherein the interpretation statement comprises a summary or description of information that the code or instructions are configured to obtain from the data source.

9. The method of claim 1, wherein the interpretation statement indicates data objects or criteria used to retrieve the set of results.

10. The method of claim 1, wherein the interpretation statement indicates at least one of (i) a mapping between one or more terms of the prompt to one or more corresponding data objects, wherein the mapping was determined by the one or more AI/ML models, or (ii) one or more formulas or equations that indicate how a portions of the set of results was calculated.

11. The method of claim 1, wherein providing the output comprises providing output that causes a particular term of the prompt to be annotated or visual distinguished from other terms in the prompt; and
wherein the interpretation statement designates an attribute, metric, or other data object that is interpreted to represent the particular term.

12. The method of claim 1, wherein the code or instructions comprise executable or interpretable code.

13. The method of claim 1, wherein the code or instructions include data filtering parameters or data aggregation parameters for generating the set of results; and
wherein the interpretation statement indicates the data filtering parameters or data aggregation parameters.

14. The method of claim 1, wherein obtaining the code or instructions comprises providing, to the one or more AI/ML models, a data model or data schema for one or more data sources, wherein the code or instructions include references to data objects in the data model or data schema; and
wherein the interpretation statement includes references to the data objects in the data model or data schema.

15. The method of claim 1, wherein the interpretation statement is generated by analyzing the code or instructions together with a data model or data schema for the data source.

16. The method of claim 1, wherein the interpretation statement comprises text generated by the one or more AI/ML models in response to a request to summarize or explain interpretations used in the generated code or instructions.

17. A system comprising:
one or more computers; and
one or more computer-readable media storing instructions that are operable, when executed by the one or more computers, to cause the system to perform operations comprising:
receiving, by the one or more computers, a prompt from a user;
obtaining, by the one or more computers, code or instructions generated by one or more artificial intelligence or machine learning (AI/ML) models, wherein the code or instructions specify criteria to retrieve data from a data source to respond to the prompt;
determining, by the one or more computers, that the code or instructions specify multiple stages of data processing;
generating, by the one or more computers, a set of results from the data source based on the generated code or instructions;
obtaining, by the one or more computers, a response to the prompt that the one or more AI/ML models generate using at least a portion of the set of results;
generating, by the one or more computers, an interpretation statement that describes each of the multiple stages of data processing; and
providing, by the one or more computers, output that includes (i) the response to the prompt and (ii) the generated interpretation statement.

18. The system of claim 17, wherein the code or instructions comprise a structured query language (SQL) statement.

19. The system of claim 18, wherein determining that the code or instructions specify multiple stages of data processing comprises determining that the SQL statement includes multiple select commands, includes a join command, or involves creation of multiple tables.

20. One or more non-transitory computer-readable media storing instructions that are operable, when executed by one or more computers, to cause the one or more computers to perform operations comprising:
receiving, by the one or more computers, a prompt from a user;
obtaining, by the one or more computers, code or instructions generated by one or more artificial intelligence or machine learning (AI/ML) models, wherein the code or instructions specify criteria to retrieve data from a data source to respond to the prompt;
determining, by the one or more computers, that the code or instructions specify multiple stages of data processing;
generating, by the one or more computers, a set of results from the data source based on the generated code or instructions;
obtaining, by the one or more computers, a response to the prompt that the one or more AI/ML models generate using at least a portion of the set of results;
generating, by the one or more computers, an interpretation statement that describes each of the multiple stages of data processing; and
providing, by the one or more computers, output that includes (i) the response to the prompt and (ii) the generated interpretation statement.
